(19) United States
(12) Patent Application Publication
(10) Pub. No.: US 2024/0189818 A1
(43) Pub. Date: Jun. 13, 2024

(54) SYSTEMS FOR AUTOMATED CONTROL OF FLUIDIC DEVICES AND METHODS THEREOF

(71) Applicant: Mayo Foundation for Medical Education and Research, Rochester, MN (US)

(72) Inventors: Alan M. Gonzalez Suarez, Rochester, MN (US); Alexander Revzin, Rochester, MN (US); XuHai Huang, Rochester, MN (US); Alexander Long, Northfield, MN (US)

(21) Appl. No.: 18/533,857

(22) Filed: Dec. 8, 2023

Related U.S. Application Data
(60) Provisional application No. 63/431,222, filed on Dec. 8, 2022.

(51) Int. Cl. B01L 3/00

(52) U.S. Cl. CPC B01L 3/502738; B01L 2200/0684; B01L 2300/0663; B01L 2300/087; B01L 2300/14; B01L 2400/0487; B01L 2400/0666

(57) ABSTRACT

This document provides integrated systems for controlling fluid flow in a fluidic device. Methods of using such systems are also described herein.

### CROSS-REFERENCE TO RELATED APPLICATIONS

This application claims the benefit of U.S. Patent Application Ser. No. 63/431,222, filed on Dec. 8, 2022. The disclosure of the prior application is considered part of (and is incorporated by reference in) the disclosure of this application.

### TECHNICAL FIELD

This document relates to integrated systems for controlling fluid flow in a fluidic device. Methods of using such systems are also described herein.

### BACKGROUND INFORMATION

Microfluidic devices can be useful tools that enable rapid, low-cost, and automated biological or chemical assays. Operation of such devices generally includes systems to transport fluid or to otherwise manipulate sample and reagents within the channel of the device.

### SUMMARY

This document provides integrated systems for controlling fluid flow in a fluidic device. In non-limiting embodiments, the system includes dual pressure modules to control different layers within a fluidic device (e.g., a microfluidic device). Methods of using such systems are also described herein.

Accordingly, in a first aspect, the present disclosure encompasses an integrated system for controlling fluid flow in a microfluidic device, wherein said system includes: (a) a first pressure module configured to control pressure within a control layer of said microfluidic device; (b) a second pressure module configured to control pressure within a flow layer of said microfluidic device; and (c) an electronics module configured to transmit and receive one or more signals between (i) said electronics module and (ii) said first pressure module, said second pressure module, or both said first and said second pressure modules.

In some embodiments, the system further includes: (d) a housing configured to house said first pressure module, said second pressure module, and said electronics module.

In other embodiments, the system further includes: (e) a user interface configured to transmit and receive one or more signals between said user interface and said electronics module.

In particular embodiments, the control layer includes one or more valves. In other embodiments, the flow layer includes one or more flow channels, and said one or more valves of said control layer are configured to control flow within at least one of said one or more flow channels of said flow layer.

In some embodiments, the first pressure module is configured to provide pressure to said control layer in a range from about 10 to about 100 psi or greater than about 10 psi. In other embodiments, the second pressure module is configured to provide pressure to said flow layer in a range from about −10 to about 10 psi or about −20 to about 20 psi.

In some embodiments, the first pressure module includes one or more of the following:
(i) one or more control valves;
(ii) a pump configured to provide increased pressure to at least one of said one or more control valves;
(iii) an optional accumulator configured to be in fluidic communication with said pump and at least one of said one or more control valves;
(iv) a vent configured to decrease pressure in said first pressure module; and
(v) an optional high pressure sensor configured to provide a pressure reading within said first pressure module.

In other embodiments, the second pressure module includes one or more of the following:
(i) one or more control valves;
(ii) a pump configured to provide increased pressure to at least one of said one or more control valves;
(iii) an optional accumulator configured to be in fluidic communication with said pump and at least one of said one or more control valves;
(iv) a vent configured to decrease pressure in said second pressure module;
(v) a vacuum source configured to provide decreased pressure to at least one of said one or more flow channels in said flow layer; and
(vi) an optional low pressure sensor configured to provide a pressure reading within said second pressure module.

In any embodiment herein, the one or more control valves includes a solenoid valve.

In any embodiment herein, the first pressure module is configured to provide positive pressure to said control layer.

In any embodiment herein, the second pressure module is configured to provide positive pressure, negative pressure, or both positive and negative pressure to said flow layer.

In any embodiment herein, the electronics module further includes:
(i) a controller configured to provide instructions to said first pressure module, said second pressure module, or both said first and said second pressure modules;
(ii) an optional driver configured to receive instructions from said controller and to transmit said instructions to a pump in said first pressure module, a pump in said second pressure module, or a pump in said first pressure module and a pump in said second pressure module;
(iii) an optional power module configured to receive instructions from said controller and to transmit said instructions to a vent in said first pressure module, a vent in said second pressure module, or a vent in said first pressure module and a vent in said second pressure module;
(iv) an optional transistor array configured to receive instructions from said controller and to transmit said instructions to one or more control valves of said first pressure module or of said second pressure module or to at least one valve of said first pressure module and at least one valve of said second pressure module; and
(v) an optional pressure sensor configured to receive pressure information from said first pressure module, from said second pressure module, or from said first and said second pressure modules and to transmit said pressure information to said controller.

In any embodiment herein, the housing further includes:
(i) a first port configured to provide a connection between said first pressure module and said control layer of said microfluidic device;
(ii) a second port configured to provide a connection between said second pressure module and said flow layer of said microfluidic device; and
(iii) an optional third port configured to provide a connection between said electronics module and said user interface.

In any embodiment herein, the system can further include: a data transmitter configured to transmit or receive data between said user interface and said electronics module or between said user interface and a storage medium.

In any embodiment herein, the system does not include an external pressure source or an external pressure regulator.

In another aspect, the present disclosure encompasses a method for controlling fluid flow in a microfluidic device, said method including:
(a) providing a system (e.g., any described herein);
(b) fluidically connecting a first pressure module to a control layer of said microfluidic device, wherein said control layer includes one or more valves;
(c) fluidically connecting a second pressure module to a flow layer of said microfluidic device, wherein said flow layer includes one or more flow channels; and
(d) adjusting a pressure within said first pressure module, said second pressure module, or both said first and said second pressure modules to control fluid flow within at least one of said one or more flow channels,
wherein (b) and (c) can be conducted at the same time or in any order.

In some embodiments, said adjusting the pressure within said first pressure module includes actuating at least one of said one or more valves in said control layer.

In some embodiments, said adjusting the pressure within said second pressure module includes flowing a fluid in at least one of said one or more flow channels in said flow layer.

In other embodiments, said first pressure module is configured to provide pressure to said control layer in a range from about 10 to about 100 psi.

In yet other embodiments, said second pressure module is configured to provide pressure to said flow layer in a range from about −20 to about 20 psi.

In other embodiments, said first pressure module is configured to provide pressure to said control layer in a range from about 10 to about 100 psi, and said second pressure module is configured to provide pressure to said flow layer in a range from about −20 to about 20 psi.

In some embodiments, said first pressure module is configured to provide positive pressure to said control layer. In other embodiments, said second pressure module is configured to provide positive pressure, negative pressure, or both positive and negative pressure to said flow layer. In yet other embodiments, said first pressure module is configured to provide positive pressure to said control layer; and said second pressure module is configured to provide positive pressure, negative pressure, or both positive and negative pressure to said flow layer.

In some embodiments, said adjusting in (d) includes: delivering a test sample to at least one of said one or more flow channels.

In other embodiments, the method further includes: reacting, treating, or preparing said test sample; and imaging said microfluidic device.

### Definitions

By “fluidic communication,” as used herein, refers to any duct, channel, tube, pipe, chamber, or pathway through which a substance, such as a liquid, gas, or solid may pass substantially unrestricted when the pathway is open. When the pathway is closed, the substance is substantially restricted from passing through. Typically, limited diffusion of a substance through the material of a plate, base, and/or a substrate, which may or may not occur depending on the compositions of the substance and materials, does not constitute fluidic communication.

By “microfluidic” or “micro” is meant having at least one dimension that is less than 1 mm. For instance, a microfluidic structure (e.g., any structure described herein) can have a length, width, height, cross-sectional dimension, circumference, radius (e.g., external or internal radius), or diameter that is less than 1 mm.

As used herein, the terms “top,” “bottom,” “upper,” “lower,” “above,” and “below” are used to provide a relative relationship between structures. The use of these terms does not indicate or require that a particular structure must be located at a particular location in the apparatus.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 shows a non-limiting control system for automated operation of microfluidic devices. (A) The control system can include pneumatic and electronic components in pressure modules and electronic modules, respectively, to autonomously operate an automated microfluidic device. (B) Image of a microfluidic device and its non-limiting functions. Negative pressure is applied to pull a sample (e.g., plasma) into the device, while positive pressure is applied to flow solutions into the analysis unit and optionally remove bubbles. Microvalves can be configured to connect analysis units in series for filling with the sample and can be later reconfigured to sequester individual analysis units and commence mixing of sample and reagents (e.g., mixing of plasma and glucose assay reagents). An analysis unit can include any useful chambers, channels, compartments, reservoirs, and the like (e.g., plasma and reagent compartments having any useful volume).

FIG. 2 shows a non-limiting prototype of an automated microfluidic system.

FIG. 3A-3C shows a non-limiting automated control system for microfluidic devices. (A) Photograph of the control system describing components. (B) Setup of the microfluidic device on an inverted microscope while operated by the control system. (C) Diagram of component connections inside the control system and its interface with the microfluidic device.

FIG. 4A-4C shows non-limiting high- and low-pressure circuits of the control system. (A) Diagram for the high-pressure circuit of the control system showing all components used to generate positive pressure to actuate all microvalves. The outlets 1 to 6 from the solenoid valves are connected to the microvalves in the microfluidic device.

( ) Diagram for the low-pressure circuit to generate both positive and negative pressure to control the flow layer of the microfluidic device. The range of pressure the system provides is from −5 to 5 psig. The outlets 1 to 3 from the solenoid valves are connected to the fluid flow channels from the microfluidic device. (C) Microvalves actuation using the control system. Scale bar=500 μm.

FIG. 5A-5C shows pressure stability as a function of time. (A) Graph showing the stability of the high-pressure system for up to 25 psig. (B) Stability of the low-pressure system from 0 to a maximum pressure of 5 psig. (C) Stability of the second branch of the low-pressure system that provides negative pressure ranging from 0 to −5 psig.

FIG. 6A-6D shows plasma separation quality assessment. (A) Schematic of the microfluidic device used for plasma separation. Scale bar=3 mm. The gray circle denotes the plasma separation membrane (PSM), and the darker gray channels denote the plasma collection microchannel. (B) Microfluidic device showing the PSM (dark area with dotted line) where the sample is deposited, and an empty collection microchannel before plasma extraction. (C) During plasma extraction, plasma travels through the PSM filling the collection microchannel, while all blood cells are retained in the PSM. Scale bar=2 mm. (D) Absorbance values for plasma separated using the microfluidic device and control system compared to separation by centrifugation.

FIG. 7A-7D shows non-limiting microfluidic devices. (A) Microscope image of a non-limiting automated microfluidic device for plasma analysis. (B) Cross-sectional schematic of non-limiting layers and valves within a device. (C) Microscope image of a non-limiting valve region showing mixing. (D) Schematic of a non-limiting device 10.

FIG. 8A-8B shows (A) a non-limiting flow diagram for an automated glucose assay and (B) a non-limiting electrical schematic of the onboard PCB for controlling the solenoid valves and pressure sources. The PCB shows connections from the microcontroller to two amplifiers to power up the solenoid valves, and connections to receive the readings coming from the pressure sensors. The system is powered up with an external 12V power source.

FIG. 9A-9D shows using a non-limiting control system to perform a mix-and-read assay in a microfluidic device. (A) A sequence of steps performed by the control system and a microfluidic device. (B) Schematic of the automated microfluidic device for plasma separation and biomarkers analysis. Channels connected to inlets, outlets, and vacuum (labeled “plasma inlet,” “air inlet,” “reagents inlets/outlets,” and “vacuum”) represent fluid flow channels (such as “plasma collection microchannel” and “reaction chambers”); while channels connected to ports for microvalves (labeled “V1” to “V6”) represent all microvalves. (C) Micrograph showing the plasma and reagent compartments before mixing. Enzymatic reaction has not yet started. (D) Micrograph of the same analysis unit shown after 8 minutes (min) of actively mixing contents of plasma and reagent compartments. Intensity of magenta color correlates with glucose concentration in the sample. Scale bar=500 μm.

FIG. 10A-10C shows microscope images of a non-limiting plasma analysis microfluidic device for executing a glucose assay using the automated microfluidic system. Provided are images of (A) an empty microfluidic channel; (B) extracted plasma and assay reagent in the mixing chambers; and (C) enzymatic reaction after peristaltic mixing between the sample and assay reagents.

FIG. 11A-11D shows a non-limiting implementation of automated image analysis. A MATLAB script was used to automatically analyze acquired images and generate concentration values. (A) Original image acquired using an inverted microscope. (B) The reagents chamber was detected, and its edges (box) and geometrical centroid (star) were determined for analysis. (C) A region of interest (ROI) of 100×300 pixels (box) was created for analysis. (D) Each color channel was separated and analyzed individually for the posterior calculation of magenta intensity in the ROI (boxes in image).

FIG. 12A-12C shows performing glucose detection assays in a microfluidic device operated by a non-limiting control system. (A) Images of microchambers with different concentrations of glucose. Scale bar=500 μm. (B) Correlating intensity of magenta color and glucose concentration to construct a calibration curve. Limit of detection (LOD) for this assay was 0.134 mM (n=3). (C) Comparing levels of glucose in blood determined using a microfluidic device and a standard glucose kit (n=3). 95% confidence intervals are plotted as grey dotted lines.

FIG. 13A-13C shows non-limiting glucose assay steps in a microfluidic device. (A) Schematic of a non-limiting microfluidic device with incorporated microvalves and the plasma separation membrane (PSM). (B) Activated and deactivated states of the microvalves for schematics shown in FIG. 13C. (C) Steps performed in the microfluidic device by the control box to develop a glucose assay in a blood sample. This protocol starts with all microvalves activated. (1) First, the microvalves V1, V3, V4, and V6 are deactivated to allow communication from the sample inlet to the vacuum port. (2) The blood sample is deposited in the PSM, and −1 psig is applied to the vacuum port to pull the plasma into the collection channel. (3) The microvalve V1 is activated, and V2 is deactivated. Following this, 1 psig is applied to the air and reagents inlets to push the plasma and reagents into the sample and reagents chambers, respectively. (4) The microvalve V6 is activated, thereby closing all outlets; and 4 psig are applied to the air and reagents inlets. This step removes any air bubbles trapped inside the assay chambers. (5) The microvalves V2 and V4 are activated to sequester each assay unit independently and prevent cross contamination between adjacent chambers. (6) The contents of the sample and reagents chambers are actively mixed for 8 min to develop the glucose enzymatic reaction. For this, the microvalves V3 and V5 are activated and deactivated sequentially every 100 ms, resulting in a fully developed reaction after the 8 minutes. After this, images of all assay units can be acquired.

### DETAILED DESCRIPTION

This document provides methods and materials for controlling fluid flow in a fluidic device (e.g., a microfluidic device). Operation of microfluidic devices can be accomplished in many ways. For laboratory-based use, such operation can include expensive and bulky pieces of equipment, such as micropumps, syringe pumps, and/or low-pressure regulators to manipulate or control fluid within the device. Yet, portable systems can be useful in point-of-care (POC) settings, in which the system can be configured to be moved or transported to the site of sample collection. Accordingly, described herein are integrated systems that can be configured to be portable, while also providing effective control of fluid flow within a fluidic device.

Any fluidic device can be employed with the systems and methods described herein. In particular embodiments, the device is a microfluidic device having one or more microfluidic features (e.g., as described herein, such as a microchannel or a microvalve). In some non-limiting embodiments, the device includes one or more Quake-style microvalves (see, e.g., Unger M A et al., “Monolithic Microfabricated Valves and Pumps by Multilayer Soft Lithography,” Science 2000; 288: 113-116, which is incorporated herein by reference in its entirety). Such microvalves can be useful for, e.g., microfluidic automation, large scale fluidic circuits, and the like. Yet, these microvalves typically require high-pressure for actuation. High-pressure control systems can be developed to provide customized pneumatic control systems for actuation of Quake-style microvalves, but lab-based systems tend to be non-portable and suited for highly specialized microfluidic laboratories. There is a need for portable systems capable of providing high-pressure actuation, and described herein are integrated systems and methods that are compatible for such use.

In addition to valve actuation, the systems and methods herein can be employed to transport fluid through flow channels. Described herein are flow channels, which can be provided in a flow layer. In turn, the flow layer can be employed with a control layer that provides one or more valves. Using the integrated systems herein, a single system can be employed to actuate valves (in the control layer) and transport fluid through flow channels (in the flow layer). While pressure required to actuate valves and transport fluid can vary, the integrated system herein can be designed to accommodate a range of pressure values. Furthermore, the integrated system can be designed to provide both positive and negative pressure to the device, thereby allowing for fluids to be pushed forward or to be withdrawn through the flow channels. In other instances, only positive pressure can be employed to push fluid through flow channels.

The integrated system can be employed with other useful components to allow for detection of desired targets or analytes. For example and without limitation, such components can include an on-board camera for visualization or imaging; a potentiostat for electrochemical or optical detection of results of biological assays; a heater to provide temperature cycling, and the like. Other components are described herein.

In some embodiments, the system is configured to enable valve actuation and pumping in microfluidic devices. In particular non-limiting embodiments, the system includes a dual pressure regulation configuration designed to operate valves and control flow in a microfluidic device. In non-limiting examples, such a dual configuration includes a first pressure module and a second pressure module, in which the first pressure module is configured to regulate, operate, or actuate a valve; and in which the second pressure module is configured to control fluid flow within a flow channel. By employing such a configuration, external pumps or pressure regulators are not required, thereby providing a portable system.

Optionally, the system can be configured for automated control. In some embodiments, the system is configured to enable automated control of microfluidic devices. In other embodiments, the system is configured to enable automated valve actuation and pumping in microfluidic devices. Thus, in some embodiments, the system can include a built-in controller/mini-computer that may be pre-programmed to operate a microfluidic device autonomously, without requiring a physical connection to computer. Such an automated system can simplify use by different users (e.g., non-medically trained personnel, patients themselves, etc.), as well as accommodate use in different settings (e.g., POC settings outside of a central laboratory). In particular embodiments, the system can include a user interface (e.g., a touch-screen display that can optionally include a processor) having one or more features to initiate an assay and will inform the user of assay progression/completion. Furthermore, the system can include onboard measurement capabilities that can be integrated with flow control features (e.g., any described herein), and such measurement capabilities can include any useful mode of detection (e.g., optical, electrical, chemical, and/or electrochemical modes).

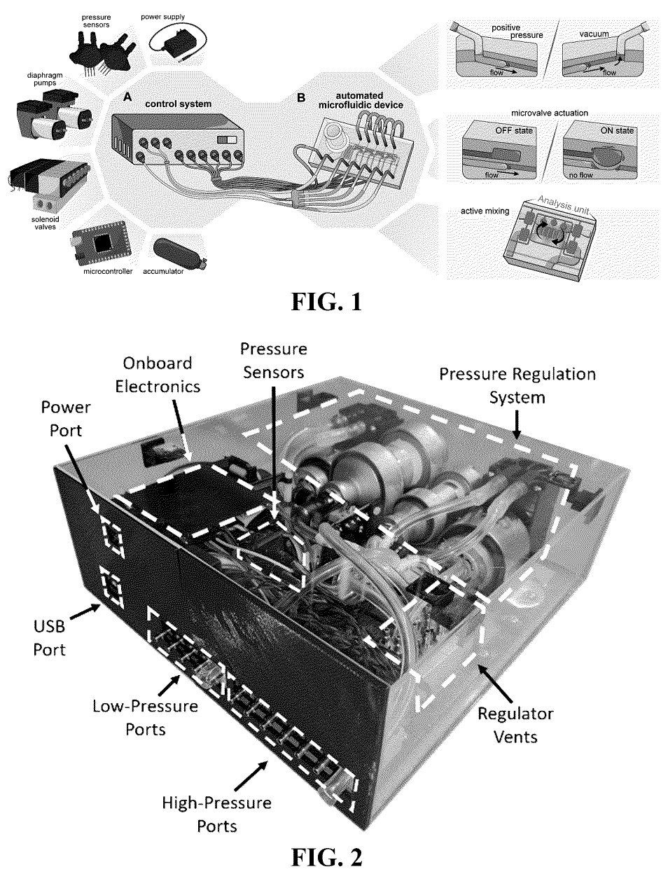

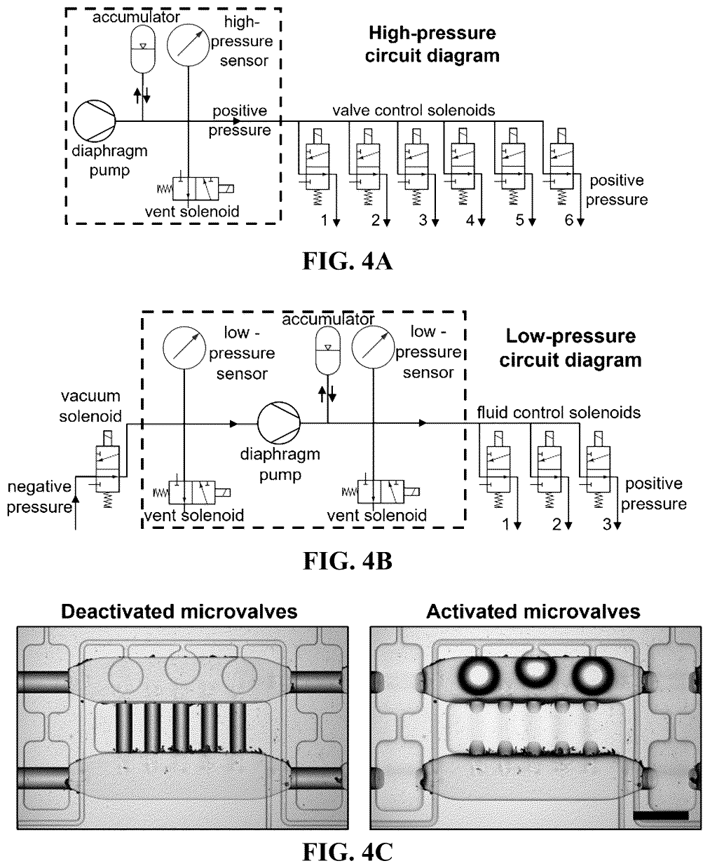

FIG. 1 shows a schematic of a non-limiting integrated system, and FIG. 2 shows a non-limiting prototype. In some embodiments, the system includes a standalone, cost-effective, and programmable pneumatic microfluidic control system in a compact form factor (e.g., about 9″×9.5″×3″). In some non-limiting embodiments, the system can include an electronics module (e.g., on board electronics) and a pressure regulation system having one or more pressure modules. The pressure module can be any described herein (e.g., as in FIG. 4A-4C). One or more pressure sensors can be used to communicate pressure information between the electronics module and the pressure module(s). In some embodiments, one or more regulator vents can be used to remove or provide air into the pressure module(s).

The system can include any useful ports to connect internal components to external components, e.g., a power port to connect the electronics module to a power source; a USB port to connect the electronics module to a user interface, a storage medium, or other external data storage device; one or more high-pressure ports to connect a first pressure module to one or more valves (e.g., within a control layer) of a microfluidic device; and/or one or more low-pressure ports to connect a second pressure module to one or more flow channels (e.g., within a flow layer) of a microfluidic device. Such ports can be provided within a housing, which in turn can be configured to house the pressure modules and electronics modules.

In some embodiments, the system can include a custom printed circuit board (PCB) with integrated pressure sensors and a microcontroller, a vacuum pump controller PCB, solenoids, vacuum pumps, an accumulator, and an optional camera module, depending on the configuration. In particular, the system can include an onboard pressure source and regulation, thus allowing the system to be operated independently of any external pressure source (e.g., such as in-house air in laboratories). Additional details regarding pressure modules, electronics modules, and other components are described herein.

### Pressure Modules

The present document describes a dual pressure system, which in turn can include a high-pressure module and a low-pressure module. The high-pressure module can be configured for valve actuation (e.g., within a control layer of a microfluidic device), and the low-pressure module can be configured for control of flow in a flow channel (e.g., within a flow layer of the microfluidic device). In some non-limiting embodiments, the low-pressure module can be further configured to provide a vacuum, thereby enabling the system to deliver a fluid into a flow channel with either positive pressure or negative pressure. Connections between pressure modules and the microfluidic device can be formed in any useful manner (e.g., by way of ports, connectors, ferrules, and the like).

In some embodiments, the high-pressure module is configured to provide a pressure in the range from about 10 to about 100 psi, from 10 to 60 psi, from 10 to 30 psi, from 5 to 25 psi, from 1 to 25 psi, from −30 to 30 psi, or from −25 to 25 psi, and the like; or greater than about 5 psi, 10 psi, 15 psi, 20 psi, 25 psi, 30 psi, 35 psi, 40 psi, 45 psi, 50 psi, 60 psi, or more.

In some embodiments, the low-pressure module is configured to provide a pressure in the range from about −5 to about 5 psi, from −10 to about 10 psi, from −20 to about 20 psi, from −3 to about 3 psi, from 0 to about 5 psi, from 0 to about 10 psi, or 0 to about 20 psi, and the like.

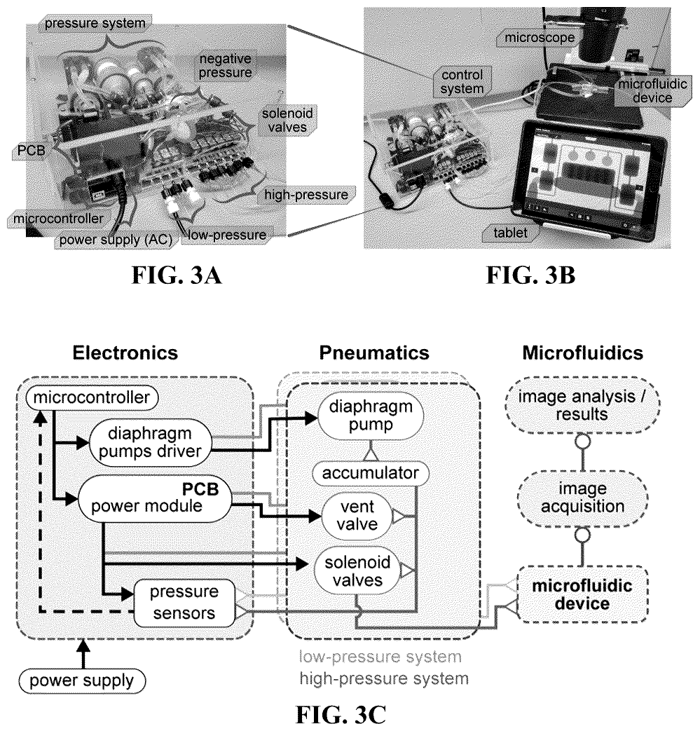

The high-pressure module can include a pump to control pressure within the control layer. In some embodiments, the pump is a vacuum pump (e.g., a 12V vacuum pump) that is fluidically connected to an accumulator (e.g., an h-accumulator). In some embodiments, the accumulator includes a reservoir or cavity that allows it to accumulate pressurized air, thereby providing stabilized pressure delivery to the valves. In particular embodiments, the accumulator can be configured as a pulsation or vibration dampener. Non-limiting accumulators include, e.g., a bladder accumulator, a hydropneumatic accumulator, and the like, as well as miniaturized forms thereof. The pump (e.g., an outlet of the pump) can be connected (e.g., sequentially connected) to a splitter (e.g., a 3-way splitter), which in turn can be connected to a pressure sensor (e.g., a high-pressure sensor), a vent (e.g., a 3-way normally open solenoid or vent solenoid), and one or more control valves (e.g., a plurality of control valves, such as a plurality of 3-way normally open solenoids or valve control solenoids). As described herein, connections can be any that provides fluidic communication between the provided components. Optionally, each component (e.g., solenoid) can be provided in connection with a manifold (e.g., a m-station solenoid manifold mounted with an m number of 3-way normally open solenoids or vent solenoids; or an n-station solenoid manifold mounted with an n number of 3-way normally open solenoids or control valves, in which each of m and n is, independently, an integer of 1 or more, including 1 to 100). Yet other components for the high-pressure module can include a check valve, a pressure relief valve, and the like. Non-limiting examples of high-pressure modules are provided in FIGS. 3C and 4A.

The low-pressure module can be assembled in a similar manner or a different manner than the high-pressure module. In one embodiment, the low-pressure module can include a vacuum source (e.g., provided by way of a 3-way normally open solenoid or vacuum solenoid) and a first splitter, which in turn can be connected to a first pressure sensor (e.g., a low-pressure sensor), a first vent (e.g., a 3-way normally open solenoid or vent solenoid), and an inlet of a pump (e.g., 12V mini vacuum pump). Furthermore, the low-pressure module can include a connection between an outlet of the pump and an accumulator (e.g., an l-accumulator), which in turn can be connected to a splitter (e.g., a 3-way splitter). The splitter can then be connected to a second pressure sensor (e.g., a low-pressure sensor), a second vent (e.g., a 3-way normally open solenoid or vent solenoid), and one or more control valves (e.g., a plurality of control valves, such as a plurality of 3-way normally open solenoids or fluid control solenoids). Optionally, each component (e.g., solenoid) can be provided in connection with a manifold (e.g., a m-station solenoid manifold mounted with an m number of 3-way normally open solenoids or vent solenoids; or an n-station solenoid manifold mounted with an n number of 3-way normally open solenoids or control valves; or a p-station solenoid manifold mounted with an p number of 3-way normally open solenoids or vacuum solenoids, in which each of m, n, and p is, independently, an integer of 1 or more, including 1 to 100). Yet other components for the low-pressure module can include a check valve, a relief valve, and the like. Non-limiting examples of low-pressure modules are provided in FIGS. 3C and 4B.

Positive pressure in both the high- and low-pressure modules can be regulated in any useful manner. In one non-limiting embodiment, regulation can include setting the vacuum pump(s), pressure sensor(s), and the vent solenoid(s) in a feedback loop. In use, the vent solenoids can be configured to decrease the pressure, and the vacuum pumps can be configured to increase the pressure until the pressure sensor measures a desirable value before engaging the valve control solenoids and the flow control solenoids. The low-pressure module can be optionally configured so that the inlet of the mini-vacuum pump is used to provide negative pressure, while the outlet is used to provide positive pressure.

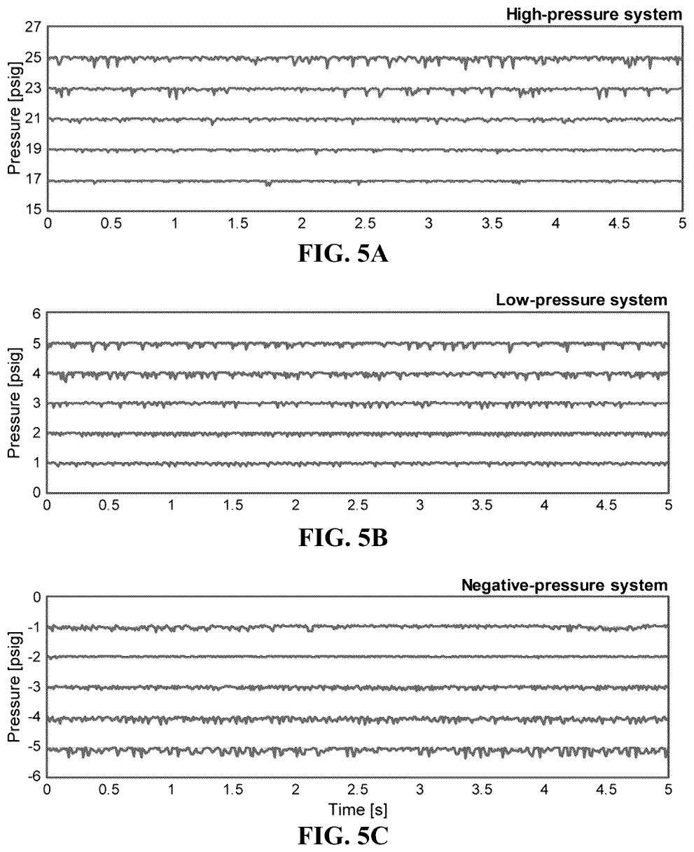

Negative pressure can be regulated in any useful manner. In one embodiment, regulation of the negative pressure can be similar to regulation of the positive pressure regulators before engaging the vacuum solenoid. Optionally, in one non-limiting embodiment, the output of the vacuum pump and mini-vacuum pump can be connected to the h-accumulator and the l-accumulator, respectively, before a splitter to increase the stability of the positive pressure source. In addition to the feedback loop, the vacuum and the mini-vacuum pump can be controlled by a pulse width modulator (PWM) (e.g., to increase the sensitivity of positive pressure control). In some embodiments, the high-pressure module can be configured to provide precise pressure control. As seen in FIG. 5, a non-limiting high-pressure can be configured to deliver up to 24 psi within 1% precision; and a non-limiting low-pressure module can be configured to operate in the range of 1 to 5 psi within 1% precision and at 0.5 psi with 3% precision.

As described herein, a pressure module can include one or more pumps. Such pumps can include vacuum pumps, diaphragm pumps, peristaltic pumps, piston pumps (e.g., rocking piston pumps), and the like, as well as miniaturized forms thereof (e.g., a helix miniature piston pump). Optionally, one or more accumulators can be employed to store pressure energy by use of a diaphragm, an incompressible fluid, a spring, and the like. Non-limiting accumulators can include hydraulic accumulators, hydropneumatic accumulators, bladder accumulators, and the like. The pressure module can include one or more valves, such as solenoid valves, proportional valves, and the like. The valves can be individually addressable or addressable in groups.

The pressure module can include pressure splitters to operate one or more control valves, thereby allowing device valves (in the control layer) or flow channels (in the flow layer) of the device to be operated in series or in parallel. In another instance, a microfluidic device can include a plurality of the device valves joined or networked together, and a single control valve in the pressure module can be used to operate a plurality of device valves.

### Electronics Module

The electronics module can include one or more electronic components configured to operate one or more components within the pressure module and/or to receive or transmit information from a user interface. In one non-limiting embodiments, the electronics module includes a printed circuit board (PCB, e.g., a custom PCB), a vacuum pump controller PCB, and a miniature computer with an optional camera module, depending on the configuration.

The electronics module can include any useful hardware (e.g., circuits, sensors, circuit components, processors, controllers, drivers, integrated circuits, logic, memory, transistors, resistors, capacitors, filters, wiring, pins, etc.). In some embodiments, the custom PCB can be mounted with a switching regulator (e.g., 12 V to 5 V switching regulator), a microcontroller, one or more high-pressure sensors, one or more low-pressure sensors, an operational amplifier (Op-Amp), an oscillator, an analog-to-digital converter (ADC), one or more transistor arrays (e.g., two Darlington transistor arrays, which can be configured to transmit instructions to one or more control valves), one or more drivers (e.g., configured to drive a pump), screw terminals, electrical connectors (e.g., insulation-displacement contact (IDC) male header box), a power connector (e.g., a DC power connector), filters, resistors, and/or capacitors.

One or more signals (e.g., electronic signals, optical signals, etc.) can be amplified, transduced, filtered, converted, compiled, split, or otherwise manipulated by the electronics module, by an electronic component, or prior to use by the electronics module. In one embodiment, a signal from the high-pressure sensor is passed into the Op Amp, configured as a 100× differential amplifier, before the readout pin. In another embodiment, a signal from the low-pressure sensor is passed through a low-pass filter before the readout pin. In yet another embodiment, a transistor array is configured to control the solenoids or control valves (optionally mounted on solenoid manifolds) by receiving parallel commands directly from the microcontroller and sending commands directly to the solenoids (or control valves) in a sequential fashion.

The electronics module can include any useful hardware (e.g., a camera module), software (e.g., code, machine-based instructions, etc.), or a combination thereof to perform any method or steps described herein. In some embodiments, the hardware can include ruggedized components. In some embodiments, software can include instructions that synchronizes microfluidic automation and image acquisition such that camera is turned on and images are acquired after microfluidic assay comes to completion.

The electronics module can include one or more sensors. In addition to pressure sensors, other sensors may be present, such as a potentiostat, a strain gauge, a diaphragm sensor, an optical sensor, and the like.

The electronics module can further include data transmitter(s) or data receiver(s) to transmit or receive data between the pressure module(s), user interface, components of the electronics module, or other external components (e.g., data storage media). Data transmitters and receivers can include those that operate by way of Bluetooth, internet, WiFi, LAN, and the like.

### Integrated System

The present document relates to integrated systems having pressure module(s) and electronics module(s), as described herein. In one embodiment, the integrated system includes a housing configured to house the high-pressure module, the low-pressure module, and the electronics module (e.g., any described herein). In particular embodiments, the housing includes one or more ports configured to connect components within the housing to an external source. Non-limiting ports can include one or more USB ports (e.g., configured to connect a user interface or computer to the electronics module), power ports (e.g., configured to connect a power source to the electronics module), pressure ports (e.g., configured to connect a pressure module to a microfluidic device, such as to connect a high-pressure module to a control layer of the device and to connect a low-pressure module to a flow layer of the device), and the like. In other embodiments, the integrated system can include one or more vents (e.g., regulator vents), fittings, ports, and the like.

In some embodiments, the integrated system is portable. In particular embodiments, the system has a footprint that is about 9×9×3 inch, or 12×12×5, or at most 20 inch in one dimension. In other embodiments, the integrated system is configured to be powered by a 12V power supply.

### User Interface

The systems herein can include a user interface configured to transmit and receive one or more signals between the user interface and the electronics module. In some embodiments, the user interface is in communication with signal processing electronics (e.g., controller or processor). The user interface can include a display (e.g., a touch-screen, a tablet, a cellphone, and the like) for visually displaying one or more processes (e.g., pressure control processes, flow control processes, assay processes, etc.). The user interface can include a graphical user interface, a text-based user interface, a command-line interface, and other useful environments (e.g., augmented or virtual reality) to provide user access.

To transmit and receive data, the user interface may be directly connected to the electronics module or connected by way of Bluetooth, internet, WiFi, LAN, and the like. Optionally, such data may be encrypted prior to transmission and decrypted after receipt, and the user interface can be configured to process, store, or other otherwise access any of these data. In some embodiments, the user interface may include data ports, data receivers, data transmitters, storage media, and the like.

The user interface can be configured to execute instructions (e.g., machine-language instructions, scripts, and the like) for conducting an assay. Such instructions can cause the electronics module to provide further instructions to the pressure module(s) to initiate a flow sequence, valving sequence, or combinations thereof (e.g., any described herein for operation of a device); further instructions to the pressure sensors to provide one or more pressure readings; further instructions to adjust a pressure within the pressure module(s); further instructions to an imaging module (e.g., a camera) to capture an image of the device or a portion thereof; and/or further instructions to transmit information regarding results of the assay (e.g. to the user interface or another remote data receiver).

The user interface can be configured to execute instructions (e.g., machine-language instructions, scripts, and the like) for analyzing an image. Such instructions can cause the electronics module to provide further instructions to the imaging module to transmit data for a captured image (e.g., to the user interface, to a processor of the electronics module, or to a processor in a remote location); further instructions to process the image (e.g., by way to aligning, binarizing, normalizing, or otherwise manipulating the image); further instructions to determine a region of interest (ROI) within the image; further instructions to determine one or more measurements (e.g., intensity, gray scale value, and the like) within the ROI; and/or further instructions to transmit data related to the one or more measurements (e.g., to the user interface or another remote data receiver). Alternatively, such further instructions for image analysis can be conducted within a processor for the user interface itself or for a remote processor. Optionally, the user interface can include further components (e.g., transducers, optical lenses, objectives, filters, and the like) to facilitate image acquisition, image analysis, or other processes described herein.

Yet other instructions can include conducting an assay, analyzing an image, running individual steps of an assay, such as mixing two or more microfluidic compartments, pumping, and actuating individual or multiple Quake-style valves. Such instructions can cause the electronics module, the user interface, a mixer, an external dispenser, a liquid handling system, a transistor array, and the like to provide further instructions to transmit or receive data or information between any of these components.

### Other Components

The systems and methods herein can employ any other useful components. Such components can be provided within the integrated system or employed externally with the integrated system.

Non-limiting components include one or more detectors (e.g., optical detectors, microscopes, photodetectors, etc.); imagers (e.g., configured for image acquisition) or optical readers; heaters; light emitting diodes; optical circuit elements, such as a filter, an objective, a lens, a mirror, a dichroic mirrors, fiber optics components, or a grating; a device manifold configured to interface a microfluidic device with one or more connections (e.g., tubing, fluidic connectors, ferrules, and the like) to the pressure manifold(s); and the like.

### Microfluidic Device

The systems and methods herein can be employed with a microfluidic device. In one non-limiting embodiment, the device includes a flow layer configured to transport one or more fluids within one or more flow channels, in which at least one fluid can be a sample; and a control layer configured to provide one or more valves (e.g., device valves or microvalves) to control fluid flow within the one or more flow channels.

In use, the flow layer and control layer can be assembled together to provide a deflectable or deformable membrane disposed between a flow channel (in the flow layer) and the valve (in the control layer). Upon adding pressure to a valve in the control layer, the deflectable membrane in contract with the valve will deflect and close off (or pinch) a portion of the underlying flow channel. Such closures can include partial or complete occlusion of the flow channel. Thus, flow within the flow channel can be restricted. The spatial configuration of valves within the control layer and channels within the flow layer can be designed to provide desired actuation, flow profiles, and fluidic circuits.

The flow layer can be employed with any useful fluids, compounds, reagents, materials, and the like. In one instance, the flow layer includes at least one channel configured to deliver a test sample to a region (e.g., channels, reservoirs, chambers, structures, etc.) within the flow layer. In another instance, the flow layer includes one or more regions or features (e.g., channels, reservoirs, chambers, structures, etc.) configured to provide one or more reagents for performing an assay. In yet another instance, the flow layer includes one or more regions or features (e.g., channels, reservoirs, chambers, structures, etc.) configured to prepare a sample (e.g., by way of separating, mixing, metering, and the like). Flow channels within the flow layer can have any useful dimension (e.g., height, width, cross-sectional dimension, etc.) from about 0.01 and 1000 μm, 0.05 to 500 μm, 0.2 to 250, 1 to 100 μm, 2 to 50 μm, or 5 to 40 μm. The flow channel can have any useful width:depth aspect ratio, e.g., between about 1:1 and 50:1.

The control layer can include any useful fluid, such as air or an actuation fluid (e.g., an inert fluid, such as perfluorinated fluid; and/or a non-compressible fluid, such as water or hydraulic oils). Valves within the control layer can have any useful dimension (e.g., height, width, cross-sectional dimension, etc.) from about 0.01 and 1000 μm, 0.05 to 500 μm, 0.2 to 250, 1 to 100 μm, 2 to 50 μm, or 5 to 40 μm. The valve can have any useful width:depth aspect ratio, e.g., between about 1:1 and 50:1.

The deflectable membrane can include any useful material that can deflect in response to changes in pressure. In one non-limiting embodiment, the deflectable membrane includes an elastomer with a Young's modulus of about 10 Pa to 100 GPa, 20 Pa to 1 GPa, 50 Pa to 10 MPa, about 1 MPa, about 0.5 MPa, and ranges therebetween. In other embodiments, the membrane can have a thickness of about 0.01 to 1000 μm (e.g., about 0.02 μm, 0.03 μm, 0.05 μm, 0.1 μm, 0.2 μm, 0.3 μm, 0.5 μm, 1 μm, 2 μm, 3 μm, 5 μm, 7.5 μm, 10 μm, 12.5 μm, 15 μm, 17.5 μm, 20 μm, 22.5 μm, 25 μm, 30 μm, 40 μm, 50 μm, 75 μm, 100 μm, 150 μm, 200 μm, 250 μm, 300 μm, 400 μm, 500 μm, 750 μm, and 1000 μm, as well as ranges therebetween).

Many flow channel cross-sections, valve cross-sections, and membrane thickness profiles can be employed, e.g., including rectangular, trapezoidal, circular, ellipsoidal, parabolic, hyperbolic, and polygonal, as well as sections of the above shapes.

In some embodiments, the microfluidic device is a monolithic device, in which the structures are integrated into a single structure. For example, the monolithic device can include components of the flow layer and the control layer (e.g., flow channels, valves, as well as any inlets, outlets, or ports to provide access to flow channels and valves) within a single structure. Such monolithic devices can be manufactured in any useful manner, such as by using any useful lithography, rapid prototyping, printing (e.g., 3D printing), deposition, etching, molding processes, and the like.

The microfluidic device can include any useful configuration and number of inlets, outlets, and ports to facilitate connection between flow channels, between valves, between a flow channel to a low-pressure module, between a valve and a high-pressure module, and the like. Such inlets, outlets, and ports can optionally include one or more valves, vents, connectors, tubings, plumbing ferrules, low volume interconnects, o-rings, and the like, which can be used with tubing, pipes, or other fluidic connectors.

The flow layer, control layer, and deformable membrane can be formed from any useful material. Materials can include elastomeric materials, rigid materials (e.g., glass, silicon, and the like), inert materials, biocompatible materials, biocompatible surfaces, substrates, polymers, and the like, as well as combinations thereof. In particular embodiments, the deformable membrane is formed from an elastomeric material (e.g., an elastomeric polymer, such as poly(dimethylsiloxane), polyisoprene, polybutadiene, polychloroprene, polyisobutylene, poly(styrene-butadiene-styrene), polyurethane, silicone, and the like).

Layers and devices can be manufactured in any useful manner, such as by using any useful lithography (e.g., photolithography, electron beam lithography, etc.), rapid prototyping, printing (e.g., 3D printing), deposition, etching, molding, milling (e.g., ion-milling), processes, and the like.

Any appropriate method can be used to make a microfluidic device provided herein. For example, multilayer soft lithography techniques such as those described elsewhere (Unger et al., Science 2000; 288: 113-116; Gonzalez-Suarez et al., Anal. Chem. 2018; 90: 8331-8336; and de Hoyos-Vega et al., Microsystems Nanoeng. 2020; 6: 40, each of which is incorporated herein by reference in its entirety) can be used to make a microfluidic device provided herein.

Any appropriate type of microfluidic valve and actuator port can be used as a valve and actuator port described herein. For example, valves and actuator ports such as those described elsewhere (e.g., Thorsen et al., Science 2002; 298: 580-584; and Lee et al., Lab Chip 2018; 18: 1207-1214, each of which is incorporated herein by reference in its entirety) can be used to make one or more of the valves and actuator ports described herein.

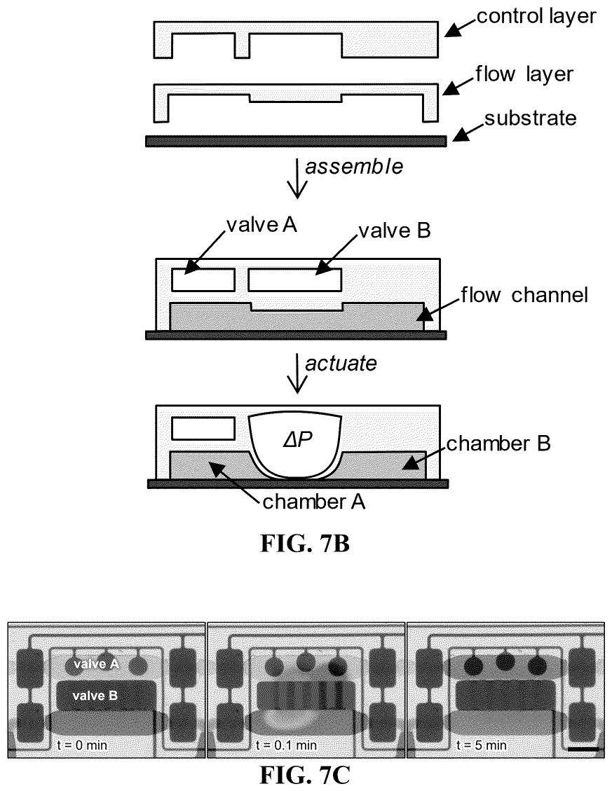

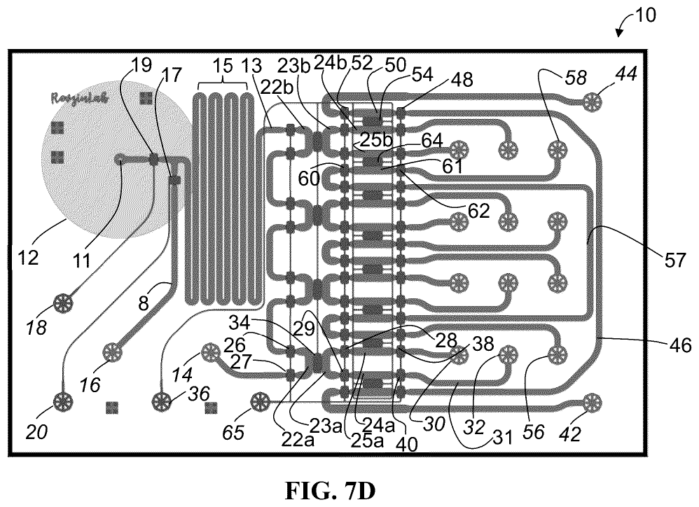

The microfluidic device can include any useful combination of fluidic components, such as channels, inlets, chambers, reservoirs, ports, etc., as well as any useful combination of valving components, such as valves, membranes, etc. FIG. 7A-7D shows schematics and images of non-limiting devices and components.

FIG. 7A shows a schematic of a non-limiting automated microfluidic device for conducting an assay. Components can include valves configured to conduct different steps within an assay. Valves can be configured in any useful manner, such as, e.g., sample separation valves (e.g., configured to load a sample into the device and isolate the sample prior to initiating the assay), mixing valves (e.g., configured to be operated in an manner to provide mixing between a sample and one or more reagents), sample reagent separation valves (e.g., configured to load a reagent into the device and isolate the reagents prior to initiating the assay), inlet valves, and outlet valves. Ports attached to valves can be configured to be connected to a high-pressure module, thereby providing fluidic communication between the high-pressure module and the control layer.

Other components can include ports in fluidic communication with flow channels in the flow layer. Such ports can include, e.g., one or more test reagent ports, control reagent ports, vacuum ports, pressurization ports, inlet ports, outlet ports, and the like. Such ports can be used to introduce samples or reagents, as well as to control flow of fluids within the flow channels. Ports attached to flow channels can be configured to be connected to a low-pressure module, thereby providing fluidic communication between the low-pressure module and the flow layer.

FIG. 7B shows a cross-sectional view of a non-limiting device having a control layer, a flow layer, and a substrate. Such layers and substrate can be assembled to provide a device having valves (valve A and valve B) and a flow channel underlying the valves. Actuation of the valves can result in control of flow within the flow channel. For instance, as seen in FIG. 7B, valve B may be actuated by increasing pressure within the valve (e.g., by use of a high-pressure module), thereby affecting flow in the underlying flow channel. Here, actuation of the valve can result in separation of the flow channel into chambers A and B. Release of valve B can then result in flow between the two chambers. Particular sequences of actuation events can be designed to provide desired flow within the channels, including transport of fluid from one region of the device to another, as well as mixing of fluid within regions of the device. For instance, valves A and B can be alternately actuated to provide mixing within the flow channels (see, e.g., FIG. 7C).

FIG. 7D provides a non-limiting microfluidic device 10 including an inlet 11 of channel 13 to receive a sample or a portion of the sample from a sample inlet area 12. Optionally, the device can include a sample inlet area configured to receive and hold a volume of a sample that can then be delivered to a channel of the microfluidic device. The volume of the sample can range from 1 μL to 100 μL (e.g., from 1 μL to 75 μL, from 1 μL to 50 μL, from 1 μL to 25 μL, from 10 μL to 100 μL, from 25 μL to 100 μL, from 50 μL to 100 μL, from 25 μL to 75 μL, from 1 μL to 10 μL, from 2 μL to 10 μL, from 3 μL to 10 μL, from 4 μL to 10 μL, from 1 μL to 9 μL, from 1 μL to 8 μL, from 1 μL to 7 μL, from 1 μL to 6 μL, from 2 μL to 8 μL, from 3 μL to 7 μL, or from 4 μL to 6 μL). In some cases, a filter or membrane (e.g., a plasma separation membrane) can be located between a sample inlet area 12 and an inlet 11 of a device to restrict at least some material of an inserted sample from entering channel 13. For example, when microfluidic device 10 includes a plasma separation membrane and whole blood is inserted into sample inlet area 12, then plasma can be allowed to enter channel 13 while cells within the sample are restricted from entering channel 13.

In some cases, microfluidic device 10 can include a vacuum port 14 configured to apply negative pressure to channel 13. In such cases, application of negative pressure can draw a sample or a portion of a sample from sample inlet area 12 into channel 13. Optionally the vacuum port 14 can be connected to the low-pressure module (e.g., by way of a low-pressure port of the integrated system and a connector, such as tubing), and application of negative pressure can be controlled by way of the electronics module.

In some cases, channel 13 can include a serpentine path 15. Channel 13 can have any appropriate length. In some cases, channel 13 can have a length from inlet 11 to vacuum port 14 that is from 10 mm to 200 mm (e.g., from 15 mm to 200 mm, from 25 mm to 200 mm, from 50 mm to 200 mm, from 75 mm to 200 mm, from 100 mm to 200 mm, from 10 mm to 175 mm, from 10 mm to 150 mm, from 25 mm to 150 mm, from 35 mm to 150 mm, from 50 mm to 150 mm, from 75 mm to 150 mm, from 100 mm to 150 mm, from 50 mm to 175 mm, from 75 mm to 175 mm, from 100 mm to 175 mm, from 125 mm to 175 mm, from 130 mm to 140 mm, from 125 mm to 145 mm, or 120 mm to 150 mm). Channel 13 can hold any appropriate volume of sample material. In some cases, channel 13 can hold a maximum volume from inlet 11 to vacuum port 14 that is from 0.5 L to 5 μL (e.g., from 0.5 μL to 5 μL, from 0.75 μL to 5 μL, from 1 μL to 5 μL, from 1.5 μL to 5 μL, from 2 μL to 5 μL, from 0.5 μL to 4.5 μL, from 0.5 μL to 4 μL, from 0.5 μL to 3.5 μL, from 0.5 μL to 3 μL, from 0.5 μL to 2.5 μL, from 0.5 μL to 2 μL, from 0.75 μL to 2 μL, or from 1 μL to 2 μL).

In some cases, microfluidic device 10 can include a positive pressure port 16, a positive pressure channel 8, a positive pressure actuator port 20, a positive pressure valve 17, a sample cutoff actuator port 18, and a sample cutoff valve 19. Optionally, the positive pressure port 16 can be connected to the low-pressure module (e.g., by way of a low-pressure port of the integrated system and a connector, such as tubing); and the positive pressure actuator port 20 and/or the sample cutoff actuator port 18 can be connected to the high-pressure module (e.g., by way of a high-pressure port of the integrated system and a connector, such as tubing). Application of pressure to the positive pressure port 16, positive pressure actuator port 20, and/or the sample cutoff actuator port 18 can be controlled by way of the electronics module.

Positive pressure valve 17 can be closed, and sample cutoff valve 19 can be open while negative pressure is being applied to vacuum port 14 to draw sample from sample inlet area 12 into channel 13, for example, along serpentine path 15. Once an adequate volume of sample is drawn into channel 13 via negative pressure, sample cutoff actuator port 18 can be activated to close sample cutoff valve 19, and positive pressure actuator port 20 can be activated to open positive pressure valve 17. At this point, positive pressure can be applied to positive pressure port 16 to provide positive pressure to positive pressure channel 8 and channel 13 to move sample within channel 13 to the one or more sample chambers 22 of channel 13.

FIG. 7D shows four sample chambers with the sample chamber of the lower part of FIG. 7D being labelled as sample chamber 22a and with the sample chamber of the upper part of FIG. 7D being labelled as sample chamber 22b. Microfluidic device 10 can include any appropriate number of sample chambers. For example, microfluidic device 10 can be configured to have one, two, three, four, five, six, seven, eight, nine, ten, or more sample chambers.

As shown in FIG. 7D, the one or more sample chambers 22 of channel 13 can be in series along channel 13. In some cases, each of sample chamber 22 of channel 13 is defined by an inflow valve 26 and an outflow valve 27. Each sample chamber 22 of channel 13 defined by inflow valve 26 and outflow valve 27 can be designed to hold any appropriate volume of sample material. In some cases, each sample chamber 22 can hold a maximum volume that is from 20 nL to 500 nL (e.g., from 20 nL to 475 nL, from 20 nL to 450 nL, from 20 nL to 425 nL, from 20 nL to 400 nL, from 20 nL to 350 nL, from 20 nL to 300 nL, from 20 nL to 250 nL, from 20 nL to 200 nL, from 20 nL to 150 nL, from 20 nL to 100 nL, from 20 nL to 75 nL, from 20 nL to 50 nL, from 30 nL to 500 nL, from 35 nL to 500 nL, from 30 nL to 100 nL, from 30 nL to 75 nL, from 30 nL to 50 nL, or from 35 nL to 45 nL). While loading each sample chamber 22 with sample, inflow valves 26 and outflow valves 27 along channel 13 can be open. Once each sample chamber 22 is loaded with sample, a master valve actuator port 65 can be activated to close inflow valves 26 and outflow valves 27 along channel 13 and isolate sample within each sample chamber 22. Optionally, valve actuator port 65 can be connected to the high-pressure module (e.g., by way of a high-pressure port of the integrated system and a connector, such as tubing), and application of pressure can be controlled by way of the electronics module.

With further reference to FIG. 7D, microfluidic device 10 can include one or more reagent chambers 23. FIG. 7D shows four reagent chambers with the reagent chamber of the lower part of FIG. 7D being labelled as reagent chamber 23a and with the reagent chamber of the upper part of FIG. 7D being labelled as reagent chamber 23b. Microfluidic device 10 can include any appropriate number of reagent chambers. For example, microfluidic device 10 can be configured to have one, two, three, four, five, six, seven, eight, nine, ten, or more reagent chambers. Typically, one sample chamber 22 is configured to be in fluidic communication with one reagent chamber 23 when a reaction control valve 34 located between them is open. For example, sample chamber 22a is in fluidic communication with reagent chamber 23a when reaction control valve 34 is open. When reaction control valve 34 is closed, sample chamber 22a and reagent chamber 23a are not in fluidic communication.

As shown in FIG. 7D, microfluidic device 10 can include a master valve actuator port 36 configured to control each reaction control valve 34. Optionally, master valve actuator port 36 can be connected to the high-pressure module (e.g., by way of a high-pressure port of the integrated system and a connector, such as tubing), and application of pressure can be controlled by way of the electronics module. In some cases, however, microfluidic device 10 can include a separate valve actuator port to control each reaction control valve 34 independently. Optionally, each separate valve actuator port can be connected to the high-pressure module (e.g., by way of separate high-pressure ports of the integrated system with associated connectors, such as tubing), and application of pressure can be controlled by way of the electronics module. In some instances, a manifold can be used to connect each separate valve actuator port to a single high-pressure port.

In some cases, each of reagent chambers 23 is defined by a reagent inflow valve 28 and a reagent outflow valve 29. Each reagent chamber 23 defined by reagent inflow valve 28 and reagent outflow valve 29 can be designed to hold any appropriate volume of reagent(s). In some cases, each reagent chamber 23 can hold a maximum volume that is from 20 nL to 500 nL (e.g., from 20 nL to 475 nL, from 20 nL to 450 nL, from 20 nL to 425 nL, from 20 nL to 400 nL, from 20 nL to 350 nL, from 20 nL to 300 nL, from 20 nL to 250 nL, from 20 nL to 200 nL, from 20 nL to 150 nL, from 20 nL to 100 nL, from 20 nL to 75 nL, from 20 nL to 50 nL, from 30 nL to 500 nL, from 35 nL to 500 nL, from 30 nL to 100 nL, from 30 nL to 75 nL, from 30 nL to 50 nL, or from 35 nL to 45 nL). While loading each reagent chamber 23 with reagent(s), reagent inflow valves 28 and reagent outflow valves 29 along reagent channel 31 can be open. Once each reagent chamber 23 is loaded with reagent(s), a master valve actuator port 65 can be activated to close reagent inflow valves 28 and reagent outflow valves 29 along channel 31 and isolate reagent(s) within each reagent chamber 23.

Microfluidic device 10 can include a reagent inlet port 30 and reagent outlet port 32 for loading reagent(s) into reagent channel 31. Any appropriate reagent or set of reagents can be loaded into a reagent chamber 23. Optionally, reagent inlet port 30 and/or reagent outlet port 32 can be connected to the low-pressure module (e.g., by way of a low-pressure port of the integrated system and a connector, such as tubing), and application of negative or positive pressure can be controlled by way of the electronics module. For loading a reagent, the reagent may be provided within a reservoir (on chip) or within a sample manifold (off chip) that is in fluidic communication with the reagent inlet port 30 and/or reagent outlet port 32 (e.g., by way of tubing or another fluidic connector).

In some cases, microfluidic device 10 can include the ability to perform similar assays being performed on the sample (e.g., a plasma sample) inserted into sample inlet area 12 on a positive control sample, a negative control sample, or both a positive control sample and a negative control sample. For example, microfluidic device 10 can include an additional valve 38 along reagent channel 31 to create a negative control reagent chamber 25 and/or an additional valve 40 along reagent channel 31 to create a positive control reagent chamber 24. FIG. 7D shows four negative control reagent chambers with the negative control reagent chamber of the lower part of FIG. 7D being labelled as negative control reagent chamber 25a and with the negative control reagent chamber of the upper part of FIG. 7D being labelled as negative control reagent chamber 25b. FIG. 7D also shows four positive control reagent chambers with the positive control reagent chamber of the lower part of FIG. 7D being labelled as positive control reagent chamber 24a and with the positive control reagent chamber of the upper part of FIG. 7D being labelled as positive control reagent chamber 24b.

Each positive control reagent chamber 24 and/or each negative control reagent chamber 25 can be loaded with reagent(s) as each reagent chamber 23 are being loaded. For example, positive control reagent chamber 24a, negative control reagent chamber 25a, and reagent chamber 23a can be loaded with the same reagent(s) via reagent inlet port 30. As another example, positive control reagent chamber 24b, negative control reagent chamber 25b, and reagent chamber 23b can be loaded with the same reagent(s) via their corresponding reagent inlet port.

Once each positive reagent chamber 24 and/or negative reagent chamber 25 is loaded with reagent(s), master valve actuator port 65 can be activated to close reagent inflow valves 28, reagent outflow valves 29, additional valves 38, and additional valves 40 along reagent channel 31 and to isolate reagent(s) within reagent chamber 23, positive reagent chamber 24, and/or negative reagent chamber 25.

In some cases, positive reagent chamber 24 and/or negative reagent chamber 25 for each reagent chamber 23 can be configured to hold the same volume as that reagent chamber 23.

When microfluidic device 10 includes a positive control for a particular assay, microfluidic device 10 can include a positive sample inlet port 42, a positive sample outlet port 44, a positive control sample channel 46, a positive sample inflow valve 48 along positive control sample channel 46, a positive sample outflow valve 52 along positive control sample channel 46, and a positive sample chamber 50 defined by positive sample inflow valve 48 and positive sample outflow valve 52. Optionally, positive sample inlet port 42 and/or a positive sample outlet port 44 can be connected to the low-pressure module (e.g., by way of a low-pressure port of the integrated system and a connector, such as tubing), and application of positive and/or negative pressure can be controlled by way of the electronics module. For loading a positive sample, the positive sample may be provided within a reservoir (on chip) or within a sample manifold (off chip) that is in fluidic communication with the positive sample inlet port 42 and/or positive sample outlet port 44 (e.g., by way of tubing or another fluidic connector).

Each positive sample chamber 50 defined by positive sample inflow valve 48 and positive sample outflow valve 52 can be designed to hold any appropriate volume of positive control material. In some cases, each positive sample chamber 50 can hold a maximum volume that is from 20 nL to 500 nL (e.g., from 20 nL to 475 nL, from 20 nL to 450 nL, from 20 nL to 425 nL, from 20 nL to 400 nL, from 20 nL to 350 nL, from 20 nL to 300 nL, from 20 nL to 250 nL, from 20 nL to 200 nL, from 20 nL to 150 nL, from 20 nL to 100 nL, from 20 nL to 75 nL, from 20 nL to 50 nL, from 30 nL to 500 nL, from 35 nL to 500 nL, from 30 nL to 100 nL, from 30 nL to 75 nL, from 30 nL to 50 nL, or from 35 nL to 45 nL). While loading each positive sample chamber 50 with positive control material, positive sample inflow valve 48 and positive sample outflow valve 52 along positive control sample channel 46 can be open and positive control material can be inserted into positive sample inlet port 42. Once each positive sample chamber 50 is loaded with positive control material, a master valve actuator port 65 can be activated to close positive sample inflow valve 48 and positive sample outflow valve 52 along positive control sample channel 46 and isolate positive control material within each positive sample chamber 50.

In some cases, one positive sample chamber 50 is configured to be in fluidic communication with one positive control reagent chamber 24 when a positive control reaction control valve 54 located between them is open. For example, positive sample chamber 50 is in fluidic communication with positive control reagent chamber 24 b when positive control reaction control valve 54 is open. When positive control reaction control valve 54 is closed, positive sample chamber 50 and positive control reagent chamber 24 b are not in fluidic communication.

As shown in FIG. 7D, microfluidic device 10 can include a master valve actuator port 36 configured to control each positive control reaction control valve 54. In some cases, however, microfluidic device 10 can include a separate valve actuator port to control each positive control reaction control valve 54 independently. Optionally, master valve actuator port 36 or separate valve actuator ports can be connected to the high-pressure module (e.g., by way of a high-pressure port of the integrated system and a connector, such as tubing), and application of pressure can be controlled by way of the electronics module.

When microfluidic device 10 includes a negative control for a particular assay, microfluidic device 10 can include a negative sample inlet port 56, a negative sample outlet port 58, a negative control sample channel 57, a negative sample inflow valve 60 along negative control sample channel 57, a negative sample outflow valve 62 along negative control sample channel 57, and a negative sample chamber 61 defined by negative sample inflow valve 60 and negative sample outflow valve 62. Optionally, negative sample inlet port 56 and/or negative sample outlet port 58 can be connected to the low-pressure module (e.g., by way of a low-pressure port of the integrated system and a connector, such as tubing), and application of positive and/or negative pressure can be controlled by way of the electronics module.

For loading a negative sample, the negative sample may be provided within a reservoir (on chip) or within a sample manifold (off chip) that is in fluidic communication with the negative sample inlet port 56 and/or negative sample outlet port 58 (e.g., by way of tubing or another fluidic connector).

Each negative sample chamber 61 defined by negative sample inflow valve 60 and negative sample outflow valve 62 can be designed to hold any appropriate volume of negative control material. In some cases, each negative sample chamber 61 can hold a maximum volume that is from 20 nL to 500 nL (e.g., from 20 nL to 475 nL, from 20 nL to 450 nL, from 20 nL to 425 nL, from 20 nL to 400 nL, from 20 nL to 350 nL, from 20 nL to 300 nL, from 20 nL to 250 nL, from 20 nL to 200 nL, from 20 nL to 150 nL, from 20 nL to 100 nL, from 20 nL to 75 nL, from 20 nL to 50 nL, from 30 nL to 500 nL, from 35 nL to 500 nL, from 30 nL to 100 nL, from 30 nL to 75 nL, from 30 nL to 50 nL, or from 35 nL to 45 nL). While loading each negative sample chamber 61 with negative control material, negative sample inflow valve 60 and negative sample outflow valve 62 along negative control sample channel 57 can be open and negative control material can be inserted into negative sample inlet port 56. Once each negative sample chamber 61 is loaded with negative control material, a master valve actuator port 65 can be activated to close negative sample inflow valve 60 and negative sample outflow valve 62 along negative control sample channel 57 and isolate negative control material within each negative sample chamber 61.

In some cases, one negative sample chamber 61 is configured to be in fluidic communication with one negative control reagent chamber 25 when a negative control reaction control valve 64 located between them is open. For example, negative sample chamber 61 is in fluidic communication with negative control reagent chamber 25b when negative control reaction control valve 64 is open. When negative control reaction control valve 64 is closed, negative sample chamber 61 and negative control reagent chamber 25b are not in fluidic communication.

As shown in FIG. 7D, microfluidic device 10 can include a master valve actuator port 36 configured to control each negative control reaction control valve 64. In some cases, however, microfluidic device 10 can include a separate valve actuator port to control each negative control reaction control valve 64 independently. Optionally, master valve actuator port 36 or separate valve actuator ports can be connected to the high-pressure module (e.g., by way of a high-pressure port of the integrated system and a connector, such as tubing), and application of pressure can be controlled by way of the electronics module.

In some cases, microfluidic device 10 can include a master valve actuator port 36 configured to control each reaction control valve 34, each positive control reaction control valve 54, and each negative control reaction control valve 64.

Further devices, flow channels, flow layers, valves, control layers, materials, fluids, samples, reagents, and the like are described in U.S. Pat. Nos. 8,220,494, 8,550,119, 9,714,443, as well as U.S. Pat. Pub. No. 2022/0080417, each of which is incorporated herein by reference in its entirety.

### Uses

The present document relates to any use of the systems herein to control or deliver fluid to a microfluidic device. Such fluid delivery can include pressure-driven flow, peristaltic pumping, active mixing, fluidic logic application, operation of fluidic circuits, and the like. Furthermore, such fluid delivery can be understood to deliver samples, reagents, buffers, solutions, agents, dyes, markers, and the like to a channel, reservoir, chamber, other features, or other regions of the microfluidic device to perform sample preparation, an assay, a reaction, or other operations.

Any appropriate sample can be assessed (e.g., for the presence, absence, or amount of one or more analytes) using the methods and materials (e.g., devices and systems) provided herein. In some cases, a sample can be a biological sample. For example, a sample can contain whole cells, cellular fragments, DNA, RNA, carbohydrates, lipids, viruses, microorganisms, and/or proteins. Examples of samples that can be used in the methods, devices, and systems described herein include, without limitation, whole blood samples, serum samples, plasma samples, urine samples, saliva samples, mucus samples, sputum samples, bronchial lavage samples, fecal samples, buccal samples, nasal samples, amniotic fluid samples, cerebrospinal fluid samples, synovial fluid samples, pleural fluid samples, pericardial fluid samples, peritoneal fluid samples, urethral samples, cervical samples, genital sore samples, hair samples, and skin samples.

In some cases, a sample to be assessed (e.g., for the presence, absence, or amount of one or more analytes) using the methods and materials (e.g., devices and systems) provided herein can be an environmental sample, a water sample, an agricultural sample, a soil sample, a food sample, a meat sample, a produce sample, a drink sample, a plant sample, a leaf sample, a root sample, a flower sample, a stem sample, a pollen sample, a seed sample, or an industrial sample (e.g., an air filter sample, sample collected from a work station, or a sample collected from a storage facility).

In some cases, the devices and systems provided herein can retain the sample within the device for safe and clean disposal.

A sample to be assessed (e.g., for the presence, absence, or amount of one or more analytes) using the methods and materials (e.g., devices and systems) provided herein can be obtained using any appropriate technique. For example, biological samples can be obtained using non-invasive (e.g., swab) techniques or invasive techniques (e.g., venipuncture, finger stick, or biopsy). In some cases, a whole blood sample can be obtained from a human (e.g., a human neonate) using a glass capillary tube. For example, an environmental sample, an agricultural sample, and/or an industrial sample can be obtained using a surface swab technique. In some cases, a sample can be a liquid sample.

A liquid sample can be any appropriate volume. As described herein, very small volumes of a sample can be collected and accurately analyzed for the presence, absence, or amount of two or more analytes using the methods and materials provided herein. For example, a liquid sample (e.g., a whole blood sample) with a volume of about 1 μL to about 10 μL (e.g., from 1 μL to 10 μL, from 2 μL to 10 μL, from 3 μL to 10 μL, from 4 μL to 10 μL, from 1 μL to 9 μL, from 1 μL to 8 μL, from 1 μL to 7 μL, from 1 μL to 6 μL, from 2 μL to 8 μL, from 3 μL to 7 μL, or from 4 μL to 6 μL) can be obtained and analyzed for the presence, absence, or amount of two or more analytes using the methods and materials provided herein. In some cases, a larger volume can be obtained from the source, and a small portion (e.g., a volume from 1 μL to 10 μL, from 2 μL to 10 μL, from 3 μL to 10 μL, from 4 μL to 10 μL, from 1 μL to 9 μL, from 1 μL to 8 μL, from 1 μL to 7 μL, from 1 μL to 6 μL, from 2 μL to 8 μL, from 3 μL to 7 μL, or from 4 μL to 6 μL) of that larger obtained volume can be used in the methods and materials (e.g., device or system) described herein.

A sample to be assessed (e.g., for the presence, absence, or amount of one or more analytes) using the methods or materials (e.g., devices or systems) provided herein can be obtained from any appropriate animal. In some cases, a sample to be assessed as described herein can be obtained from a mammal (e.g., a human such as a human neonate, human baby, human toddler, human child, or human adult). Examples of mammals that samples can be obtained from include, without limitation, primates (e.g., humans and monkeys), dogs, cats, horses, cows, pigs, sheep, rabbits, and rodents (e.g., mice and rats). Other examples of animals that samples can be obtained from include, without limitation, fish, avian species (e.g., chickens, turkeys, ostrich, emus, cranes, and falcons) and non-mammalian animals (e.g., mollusks, frogs, lizards, snakes, and insects).

In some cases, a sample to be inserted into a device or system described herein can be obtained from a source (e.g., a human neonate) and directly inserted into the device or system without being pre-processed. For example, a whole blood sample can be obtained from a mammal (e.g., a human such as a human neonate) and directly inserted into a device or system provided herein without being pre-processed (e.g., without being treated or manipulated in any way).

In some cases, a sample to be inserted into a device or system described herein can be obtained from a source (e.g., a mammal or surface) and processed prior to being inserted into the device or system (e.g., can be pre-processed). Samples that are pre-processed can be pre-processed using one or more appropriate reagents (e.g., enzymes, acids, bases, buffers, detergents, anticoagulants, and/or aptamers) and/or techniques (e.g., purification techniques, centrifugation techniques, amplification techniques, culturing techniques, and/or denaturing techniques). For example, a blood sample can be obtained from a mammal (e.g., a human) and treated with one or more anticoagulants. Examples of anticoagulants that can be used to pre-process a sample (e.g., a blood sample) include, without limitation, EDTA, citrate (trisodium citrate), heparinates (e.g., sodium, lithium, or ammonium salt of heparin or calcium-titrated heparin), and hirudin. In some cases, a sample (e.g., a sample suspected to contain a microorganism) to be inserted into a device or system described herein can be obtained from a source (e.g., a food preparation surface) and pre-processed by culturing the sample with appropriate culture media for a period of time (e.g., 4 hours to 24 hours) prior to being inserted into the device or system. Examples of other pre-processing techniques that can be performed prior to inserting the sample into a device or system described herein include, without limitation, centrifugation to obtain cell-containing material, centrifugation to obtain cell-free material, filtration to remove cell containing material, cell lysis, nucleic acid purification, protein purification, nucleic acid amplification (e.g., polymerase chain reaction (PCR)), reverse transcription to obtain cDNA, reverse transcription PCR, nucleic acid denaturation, and isothermal amplification.

The systems, devices, and methods herein can be employed to process, analyze, or otherwise manipulate a test sample. Non-limiting processes can include preparing a sample (e.g., separating one or more components of a test sample), reacting a sample (e.g., performing one or more chemical, biological, or biochemical reactions, including binding reactions, enzymatic reactions, and the like), assaying a sample (e.g., performing one or more assays, such as any described herein), and the like. Multiple assays may be run in parallel and/or serially.

Assays include, e.g., glucose assays, POC assays, and the like. Non-limiting assays also include multiple chemical and/or biochemical assay formats and/or platforms including, but not limited to, well-, microwell-, microfluidic-, gel-, magnetic particle-, solid chromatographic-based assay formats, for detecting and quantifying analytes of interest in a sample. Assay types may include, but are not limited to, sandwich, hybridization, competition, and other assays.

The systems, devices, and methods herein can be employed to detect the presence, absence, or amount of one or more analytes present within a small volume (e.g., less than 10 μL) of a sample (e.g., a blood sample) obtained from a mammal (e.g., a human such as a human neonate). For example, this document provides methods and materials for using plasma separation and multiplex analyte detection to detect two or more analytes (e.g., proteins, carbohydrates, lipids, nucleic acids, intact cells, intact viruses, intact microorganisms, and/or chemicals) within a small volume of a blood sample.

Any appropriate type of analytes can be detected using the methods and materials provided herein. For example, a device or system provided herein can be configured to detect the presence, absence, or amount of a protein, carbohydrate, lipid, nucleic acid, intact cell, intact virus, intact microorganism, and/or chemical. Examples of proteins that can be detected using the methods and materials provided herein include, without limitation, enzymes such as lactate dehydrogenase (LDH), alanine transaminase (ALT), aspartate transaminase (AST), creatine phosphokinase (CPK), and metalloproteases (e.g., ADAM12), receptors such as soluble chemokine receptors (e.g., CCRS and CXCR4), soluble growth factor receptors (e.g., EGFR), and soluble transferrin receptor, serum proteins such as albumin, transferrin, alpha-1 anti-trypsin, and immunoglobulins, inflammatory cytokines such as tumor necrosis factor alpha (TNF-α), interleukin 2 (IL-2), and interferon gamma (IFN-γ), viral proteins such as HIV envelope protein gp 120 and E protein of SARS-COV-2, bacterial proteins such as Mycobacterium tuberculosis surface protein Rv0227c and the MSCRAMM family of S. aureus, and fungal proteins such as Ssp1 and Sell. Examples of carbohydrates that can be detected using the methods and materials provided herein include, without limitation, glucose, lactate, pyruvate, prostate-specific antigen (PSA), CA 125, and CA 19-9. Examples of lipids that can be detected using the methods and materials provided herein include, without limitation, total cholesterol, triglycerides, high density lipoprotein (HDL), and low density lipoprotein (LDL). Examples of intact viruses that can be detected using the methods and materials provided herein include, without limitation, human immunodeficiency viruses (e.g., HIV1 and HIV2), coronaviruses (e.g., COVID-19 virus), Zika viruses, influenza viruses A and B, adenoviruses, RSV viruses, parainfluenza viruses, human metapneumoviruses, rhinoviruses, enteroviruses, hepatitis A, B, C and E viruses, rotaviruses, human papillomaviruses, measles viruses, caliciviruses, astroviruses, West Nile viruses, Ebola viruses, Dengue fever viruses, African swine fever viruses, herpes simplex viruses (e.g., HSV-2), Norwalk and Norwalk-like viruses, enteric adenoviruses, yellow fever viruses, chikungunya viruses, Epstein-Barr viruses, parvoviruses, varicella zoster viruses, and Ross River viruses. Examples of intact microorganisms that can be detected using the methods and materials provided herein include, without limitation, bacterial microorganisms such as Staphylococcus aureus (e.g., MRSA and MSSA), Streptococcus pyogenes, Streptococcus pneumoniae, Mycoplasma pneumoniae, Haemophilus influenzae, Chlamydia pneumoniae, Bordetella pertussis, Mycobacterium tuberculosis, E. coli (e.g., enterohaemorrhagic E. coli such as O157:H7 E. coli or enteropathogenic E. coli), Salmonella species (e.g., Salmonella enterica), Listeria monocytogenes, Acinetobacter baumanni, Klebsiella oxytoca, Sarcoptes scabiei, Neisseria gonorrhoeae, Chlamydia trachomatis, Treponema pallidum, Campylobacter species (e.g., thermophilic strains of Campylobacter jejuni, C. lari, or C. coli), Bacillus cereus, Vibrio species, Yersinia enterocolitica, Shigella species, Enterococcus species (e.g., Enterococcus faecalis or E. faecium), Helicobacter pylori, and Clostridium species (e.g., Clostridium botulinum or Clostridium perfringens), fungal microorganisms such as Aspergillus species (e.g., A. flavus, A. fumigatus, and A. niger), yeast (e.g., Candida norvegensis and (. albicans), Penicillium species, Rhizopus species, and Alternaria species, and protozoan microorganisms such as Cryptosporidium parvum, Giardia lamblia, and Toxoplasma gondii. Examples of chemicals that can be detected using the methods and materials provided herein include, without limitation, glucose, bilirubin, parathyroid hormone, bile acid, and urea.

In some cases, the methods and materials provided herein can be used in small animal research, neonatal blood analysis, analysis of blood for one or more cardiac biomarkers, point-of-care testing of infectious diseases (e.g., COVID-19, sexually transmitted diseases, or HIV), and/or point-of-care testing in an operating room to provide rapid turnaround results.

The invention will be further described in the following examples, which do not limit the scope of the invention described in the claims.

### EXAMPLES

### Example 1: A Compact Control System to Enable Automated Operation of Microfluidic Bioanalytical Assays

Automated microfluidic devices are amenable for carrying out complex multistep assays while minimizing sample volume, sample dilution, and reagent use. Microfluidic automation can be enabled by micromechanical valves (microvalves), also known colloquially as Quake-style valves. Such microvalves may be used for routing and metering flow, as well as for mixing. While microfluidic devices with integrated microvalves have a small footprint (on the order of 1 cm²), they typically rely on bulky ancillary equipment (e.g., external solenoid valves and pumps) to actuate the microvalves and flow of fluids. This makes it challenging to operate automated valve-enabled microfluidic devices at the point of use. Therefore, the objective of our study was to design a portable control system that may be deployed at the point-of-use setting to operate such devices.

Neonatology is one area where automated microfluidic devices may be particularly effective. Preterm newborns may have as little as 50 mL of total blood volume and are at an elevated risk for a number of health conditions including hypoglycemia, infections, and jaundice. To improve health outcomes, preterm infants must be carefully monitored and screened for these conditions by measuring biomarkers in the blood. Although simple and accurate methods have been developed to measure blood glucose and bilirubin, traditional lab-based blood analysis requires 200-500 μL of blood per test. For critically ill infants who require continuous monitoring, blood draws may remove up to 50% of total blood volume during the first weeks of life, putting newborns at risk of anemia and infections. Our team recently developed an automated valve-enabled microfluidic device that allows us to isolate plasma and then detect biomarkers based on an input of 5 μL of whole blood. However, in this past study, we relied on external laboratory equipment and facilities (e.g., house air, solenoid valves, vacuum pump) to operate the microfluidic device. Here, we describe a portable control system to drive operation of the valve-enabled microfluidic device and detect biomarkers of neonatal health from a small volume of human blood.

To our knowledge, prior reports of custom-made pneumatic control systems for actuation of microvalves have described electronic and pneumatic components that were engineered to create sophisticated control systems to operate automated microfluidic devices. Some of these reports describe systems that are intended for laboratory use and for operation by experienced personnel. Other reports have focused on miniaturizing pneumatic control systems for either pumping or valve actuation but not both. Therefore, to the best of our knowledge, a control system capable of both microvalve actuation and fluid flow handling has not been reported to date. In addition, we are not aware of a report where a portable control system was used to drive operation of an automated microfluidic device that carries out a complex multi-step bioassay workflow.

Herein, we describe a compact control system for fully automated operation of a valve-enabled microfluidic device. A non-limiting system and its components are described in FIG. 1 (e.g., a power supply, pressure sensors, diaphragm pumps, solenoid valves, microcontroller, accumulator, and control system). This control system was used to drive operation of a microfluidic device that performed a complex set of functions that included on-chip plasma separation, delivery of plasma into four analysis units, and active mixing of plasma with assay reagents in these analysis units (automated microfluidic device in FIG. 1).

The control system can be used to operate valve-enabled microfluidic devices to carry out a complex workflow of plasma separation from 8 μL of whole blood, followed by on-chip mixing of plasma with assay reagents for biomarker detection. Automated blood processing and glucose detection occurred in <15 min. The control system incorporates pumps, digital pressure sensors, a microcontroller, solenoid valves, and off-the-shelf components to deliver high and low air pressure in the desired temporal sequence to meter fluid flow and actuate microvalves. The control system is portable, which is suitable for operating the microvalve-enabled microfluidic devices in the point-of-care setting. Additional details follow.

### Example 2: Non-Limiting Materials and Methods

### Materials:

For all experiments, materials used are listed below.

Polydimethylsiloxane (PDMS) base and curing agent kit (Sylgard 184) was purchased from Ellsworth Adhesives (Minneapolis, MN, USA). Tubing (Tygon® ND-100-80 Microbore, 0.020″ ID×0.060″ OD) was purchased from Cole Parmer (Vernon Hills, IL, USA). The plasma separation membrane (PSM) was obtained from Cobetter Filtration as a gift (Hangzhou, China). 6 mm glass cloning cylinders (Pyrex 31666), horseradish peroxidase (HRP), and the glucose assay kit (Am-plex™ red glucose/glucose oxidase assay kit) were purchased from Thermo Fisher Scientific (Waltham, MA, USA). Phosphate buffered saline (PBS) 1× was purchased from Corning (Corning, NY, USA). Chlorotrimethylsilane, 4-aminoantipyrine (4-AAP), glucose (D-(+)-Glucose), glucose oxidase (GOx), and the hemoglobin assay kit (MAK115) were purchased from MilliporeSigma (Burlington, MA, USA). The total bilirubin assay kit (BILT3) was purchased from Roche (Basel, Switzerland). Sodium salt of N-Ethyl-N-(2-hydroxy-3-sulfopropyl)-3-methoxyaniline (ADOS) was purchased from Dojindo (Kumamoto, Japan).

### Design of the Control System:

Provided herein are details regarding fabrication of a control system to autonomously operate an automated microfluidic device for blood plasma analysis. We developed a control system that contains electronic and pneumatic components enclosed in a 280×280×80 mm acrylic box.

### Onboard Electronics:

The onboard electronics of the control system included a microcontroller (Arduino Mega 2560) connected to a custom printed circuit board (PCB), a diaphragm pump controller PCB (DFRobot), two diaphragm pumps, three digital pressure sensors (one for high and two for low pressure supply), and 13 3-way normally open solenoid valves. All onboard electronics were powered by a single 12 V power supply. 12 V were used to supply power to the diaphragm pumps, solenoid valves and high-pressure sensor. For the microcontroller and low-pressure sensors, voltage was stepped down with a 12 V to 5 V switching regulator (Recom Power) integrated into the custom PCB. The design of the PCB can be found in the following GitHub repository: github.com/RevzinLab/Control-System-for-Microfluidics (accessed on 30 Oct. 2022).

### Pneumatic System:

The pneumatics system is divided into high- and low-pressure systems for activation of microvalves and delivering sample/reagents, respectively. The high-pressure system included a diaphragm pump connected from the air outlet to a custom accumulator and sequentially to a 4-way splitter, connecting the accumulator to: (1) a digital high-pressure sensor, (2) a single solenoid valve used as a vent valve to release pressure, and (3) a 6-station manifold mounted with six solenoid valves operating as control valves for the microfluidic device. An air filter was connected to the air inlet of the diaphragm pump to avoid unwanted particles entering the system.

The low-pressure system enabled positive and negative pressure through two pneumatic circuits, one circuit connected to the air inlet of the diaphragm pump to obtain negative pressure, while the second one was connected to the air outlet of the diaphragm pump for positive pressure. For negative pressure, a 4-way splitter is used to interconnect the diaphragm pump air inlet, a solenoid valve used as a vent, a digital low-pressure sensor and a second solenoid valve that will be providing negative pressure to the microfluidic device. For positive pressure, the pneumatic circuit is similar to the high-pressure circuit, with the difference that a 4-station manifold with only three solenoid valves is used to operate fluid flow channels of the microfluidic device; the remaining station of the manifold is blocked to avoid leakage.

### Pressure and Solenoid Valves Control:

To tune pressure in our system and control operation of solenoid valves, we created an algorithm using microcontroller software (Arduino IDE v1.8.19, Arduino, Somerville, MA, USA). We first calibrated our three digital pressure sensors against laboratory pressure regulators (LU-FEZ-N345, Fluigent, 67 Av. de Fontainebleau, 94270 Le Kremlin-Bicêtre, France) following the manufacturer's recommendations to create reliable pressure readings. Then, we developed an algorithm with specific instructions to activate/deactivate diaphragm pumps and solenoid valves at specific time points based on the requirements of the assay. Diaphragm pumps and solenoid valves switching is achieved by activating/deactivating digital ports from the microcontroller. A commercial dual DC motor controller was used as an intermediate interface between the microcontroller and diaphragm pumps to deliver sufficient electrical current for activation. Similarly, we used a custom-made PCB with 16 Darlington transistor arrays (ULN2803A, STMicroelectronics, 39, Chemin du Champ des Filles, Geneva, Switzerland) to deliver current independently to each solenoid valve for activation. The Arduino code can be found in the project's GitHub repository: github.com/RevzinLab/Control-System-for-Microfluidics (accessed on 30 Oct. 2022).

Fabricating Microfluidic Devices and Connecting them to the Control System:

Briefly, two master molds were fabricated on silicon wafers by photolithographic patterning of SU-8 and AZ 10XT photoresists. These molds were replicated using polydimethylsiloxane (PDMS) to assemble a two-layer microfluidic device. This microfluidic device includes a flow layer for sample and reagents and a control layer containing microvalves to handle fluid flow in the flow layer.

The flow layer included six inlets (plasma sample, air, and four for reagents) and five outlets (one for negative pressure and four for reagents). The control layer included six independent microvalves. The microfluidic device was coupled with the control system using medical grade tubing. The air inlet from the flow layer of the microfluidic device was connected to one of the solenoid valves from the positive pressure low-pressure circuit in the control system, while all four reagent inlets were connected to a second solenoid valve, which allowed pressurization of all four reagents inlets at the same time. The outlet of the sample chambers was connected to the negative pressure low-pressure system, this allowed for plasma separation from whole blood. On the other hand, each one of the microvalves from the control layer were connected to the six solenoid valves from the high-pressure circuit in the control system, thereby allowing independent activation/deactivation of each microvalve in the microfluidic device.

### Design of Microfluidic Devices:

The microfluidic device shown in FIG. 1 integrated two modules: plasma separation and bioanalysis. The plasma separation module included a plasma separation membrane (PSM) placed in the sample inlet and a collection microchannel that can hold plasma after separation from whole blood. After dispensing 8 μL of blood into the sample inlet, vacuum (−1 psig) was applied to the outlet of the plasma separation module to pull plasma into the collection microchannel. The PSM retained all blood cells allowing only plasma to enter the collection microchannels.

The bioanalysis module included four analysis units for biomarker detection (see FIG. 1). Each analysis unit contained two 50 nL chambers for loading sample and glucose assay reagents. After the plasma was separated, it was pushed into the sample chambers at the same time that assay reagents were injected into the reagent chambers. Solutions in each analysis unit were efficiently homogenized by active mixing using two microvalves. This ensured that enzymatic reaction for glucose detection was not transport-limited and allowed for a signal to develop within 8 min of mixing. Enzymatic reactions were quantified by placing a microfluidic device on an inverted microscope with an integrated color camera (Primovert HDcam, Zeiss, Carl-Zeiss-Strasse 22, 73447 Oberkochen, Germany).

### Operating a Microfluidic Device Using the Control System:

To accomplish the desired workflow, our control system had to perform a set of specific functions. The workflow included two parts: (1) microvalve filling and activation, and (2) assay performance. Filling of the microvalves included loading microvalve tubing with DI water and connecting them to the microfluidic device and solenoid valves of the control system. After this, the control system was powered up; and all microvalves were pressurized to 25 psig for 5 min to fill all microvalve channels with DI water. Afterwards, the algorithm entered a 10 min delay to allow preparation of the assay. During the 10 min delay, reagents were loaded into the tubing and connected to both the microfluidic device and control system. Tubing for the air inlet and vacuum outlet was connected as well. The microfluidic device was set on the inverted microscope, and 8 μL of blood was dispensed into the sample inlet.

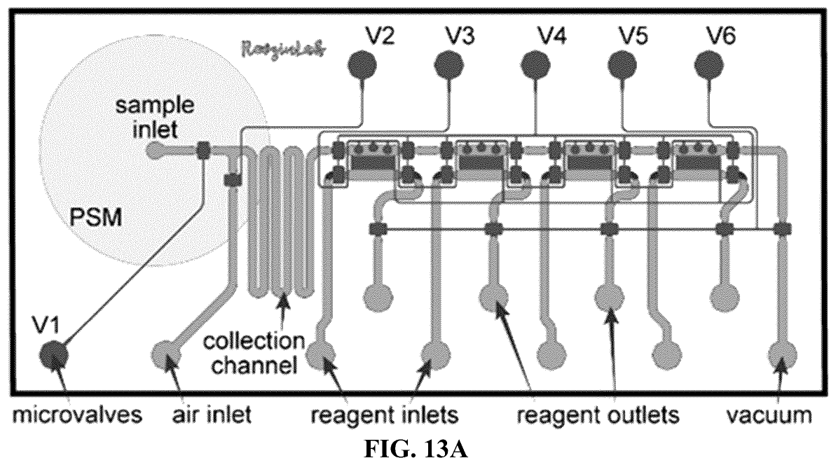

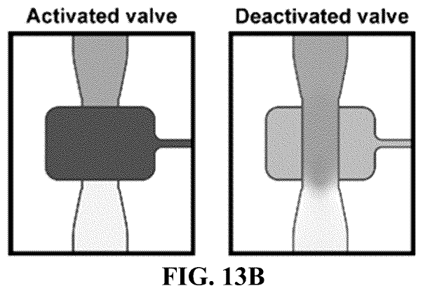

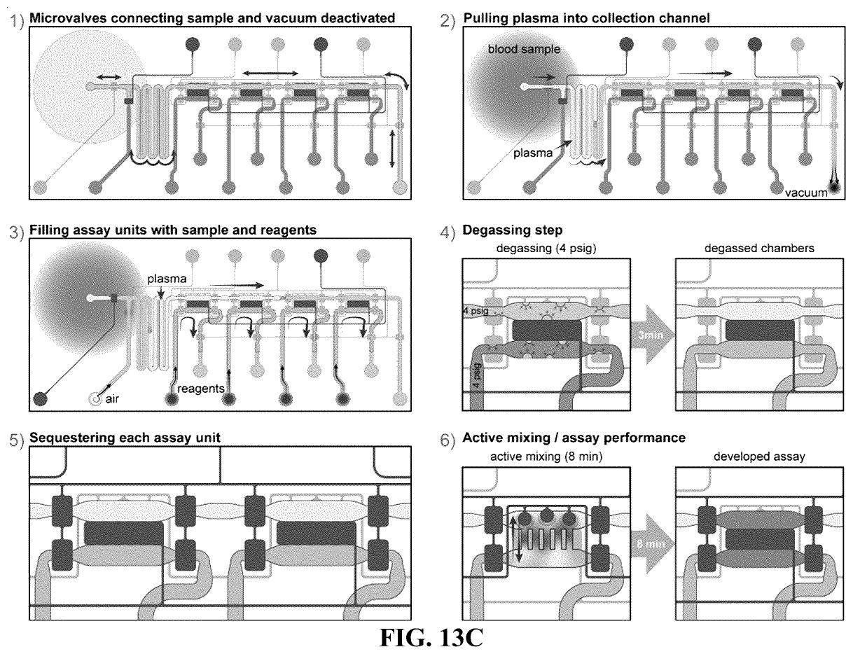

Performing glucose assay required six sequential steps. Schematics depicting the steps explained next are shown in FIG. 13A-13C. As seen in FIG. 13C, (1) microvalves connecting the PSM inlet with the vacuum outlet were deactivated to allow communication between the blood sample and negative pressure. (2) Negative pressure (−1 psig) was applied for 30 s to the vacuum port to pull the plasma through the PSM into the collection microchannel. (3) The PSM inlet microvalve was activated to block that inlet. Simultaneously, reagent and air inlet microvalves were deactivated and 1 psig was applied for 20 s to such inlets to fill reagent chambers and to push plasma from the collection microchannel into the sample chambers. (4) A degassing step was performed to remove air bubbles that could be trapped inside the reaction chambers. The outlet microvalve was activated, and 4 psig were applied for 3 min to reagents and air inlets. (5) Reaction chambers were completely depressurized, and all microvalves except for V3 (rounded microvalves on top of sample chambers) were activated. This sequestered each reaction chamber and prevented cross contamination between adjacent chambers. (6) The next step included mixing the contents of the sample and reagent chambers to develop the enzymatic reaction through active mixing. For this, we sequentially activated and deactivated microvalves V3 and V5 (microvalves separating sample and reagent chambers) for 8 min to actively mix solutions. At the end of this step, all microvalves were activated except for V3. At this point, image acquisition and quantification of enzymatic reaction began.

### On-Chip Plasma Separation:

We compared the quality of plasma isolated in a microfluidic device operated with the control system to a standard centrifugation method. For this, we used a microfluidic device that included only the plasma separation module. The device had two inlets (plasma and air) and one outlet (vacuum). On top of the plasma inlet, a PSM (8 mm in diameter) was bonded; and a sample of 8 μL of whole blood was dispensed on it. Empty tubing was connected to the air inlet and vacuum outlet. An algorithm including two steps was used for plasma separation and collection: (1) −1 psig was applied to the vacuum outlet for 2 min to pull plasma into the collection microchannel; and (2) 1 psig was applied to the air inlet to push plasma out of the device and into the outlet tubing for testing.

In parallel with on-chip blood processing, plasma was separated from the same blood sample using a centrifugation-based protocol. Briefly, blood was centrifuged at 1500 g for 12 min at 20° C. Blood cells formed a pellet at the bottom of the tube, and plasma was aspirated out. Hemoglobin absorbance levels in both types of plasma samples were determined using a commercially available kit (MAK115, MilliporeSigma, 400 Summit Drive, Burlington, MA, USA) and a spectrophotometer (NanoDrop, Thermo Fisher Scientific, Waltham, MA, USA).

### On-Chip Enzymatic Assay for Glucose Detection:

An enzymatic colorimetric assay for glucose detection was implemented. Briefly, the assay reagents were reconstituted at the following concentrations in order to increase contrast for absorbance-based measurement in the device: GOx at 70 U/mL, HRP at 117 U/mL, ADOS at 3.6 mM, and 4-AAP at 3.1 mM. Glucose solutions of varying concentrations (from 0 to 10 mM) were prepared and infused into a microfluidic device to create a 1:1 sample to reagent mixture. Upon mixing of the glucose solutions and the reagents, the solution developed a magenta-colored product with the absorbance intensity correlating to glucose concentration.

After characterizing the performance of the device using known glucose concentrations, we assessed glucose in blood. Blood samples were acquired from the Mayo Clinic blood bank and were collected into 6 mL EDTA-coated tubes. Because these were de-identified leftover blood bank samples, no IRB protocol was required. Five blood samples were used to assess the performance of the control system and automated microfluidic devices. For each sample, three analysis units were used to account for on-chip variability. Two-point calibration was run in the same device by flushing the analysis units with 1×PBS to establish a 0 mM value and then with an 8 mM glucose solution. Images were acquired for sample and calibration solutions to analyze and determine glucose concentration in the samples.

### Image Acquisition and Analysis:

Colorimetric enzymatic reaction in microfluidic devices was assessed by acquiring images in the brightfield channel using an inverted microscope and a color camera. Image analysis and data plotting was performed automatically using a custom-made MATLAB (2021b, Mathworks) script. For this, images were trimmed, and the intensity of a rectangle of 300×100 pixels (px) in the middle of the reagent chamber was measured for each color channel in the image (R, G, and B). Data were converted into the CMYK color space, and magenta channel values were used to determine the glucose concentrations of the samples. For the calibration curve, magenta intensity from images was plotted as a function of the corresponding concentration of glucose in the solution. For whole blood samples, the glucose concentration of plasma was determined by comparing against the 0- and 8-mM solutions. The MATLAB script can be found in the project's GitHub repository: github.com/RevzinLab/Control-System-for-Microfluidics (accessed on 30 Oct. 2022).

### Example 3: Design and Assembly of the Control System

We developed a control system that could be used to drive operation of a valve-enabled microfluidic device performing blood processing and biomarker detection. This microfluidic device allowed us to isolate plasma from a small volume of blood and then carry out mix-and-read assays. The device contains a plasma separation module upstream of the bioanalysis module, in which the sample is mixed with reagents to carry out an assay and detect a biomarker of interest. Operation of this microfluidic device involves equipment or facilities common in a research laboratory, but uncommon in the point-of-care setting: (1) a source of high pressure (>20 psig, air compressor, in house pressure source, etc.) is needed to actuate Quake-style valves in microfluidic devices. The source of high pressure is connected to external solenoid valves that in turn are connected to a microcontroller operated by a graphic user interface (GUI). The GUI allows the user to control each microvalve or actuate microvalves in a prescribed sequence. (2) A source of low pressure (0-5 psig) to push the sample through the device at the desired flow rate. Here, we incorporated these capabilities into a portable system.

To create a portable system, we sought to eliminate the need for an external pressure source and regulation. We designed a control system that is compact (280×280×80 mm) and only requires connection to alternating current (AC) to function, shown in FIG. 3A-3B. The system includes a microcontroller and electronics that efficiently control pneumatic elements to deliver precise pressure and, at the same time, activate/deactivate all six microvalves in the microfluidic device. The pneumatic system was divided into two: a high-pressure subsystem to control all microvalves, and a low-pressure subsystem to inject solutions into the device.

We used two miniature diaphragm pumps (mini-pumps), one for each pressure subsystem. Each mini-pump was connected to an accumulator to build up pressure and the accumulator to three different components via a 4-way splitter: a digital pressure sensor, a vent valve to release excess pressure, and a manifold with solenoid valves. The manifold for the high-pressure subsystem interfaced six 3-way solenoid valves to six microvalves in the microfluidic device. Each solenoid valve would then supply the on-chip microvalve with pressurized air (>20 psig) or with atmospheric pressure to achieve an activated or deactivated microvalve state, respectively. The low-pressure subsystem interfaced only three solenoid valves to the device with pressure in the range of −5 to 5 psig. A diagram of components in the non-limiting control system is shown in FIG. 3C. After electronic and pneumatic components were obtained, we assembled the system and put it inside an acrylic box. The assembly of the system took ˜4 h to complete.

### Example 4: Onboard Pressure Generation and Regulation

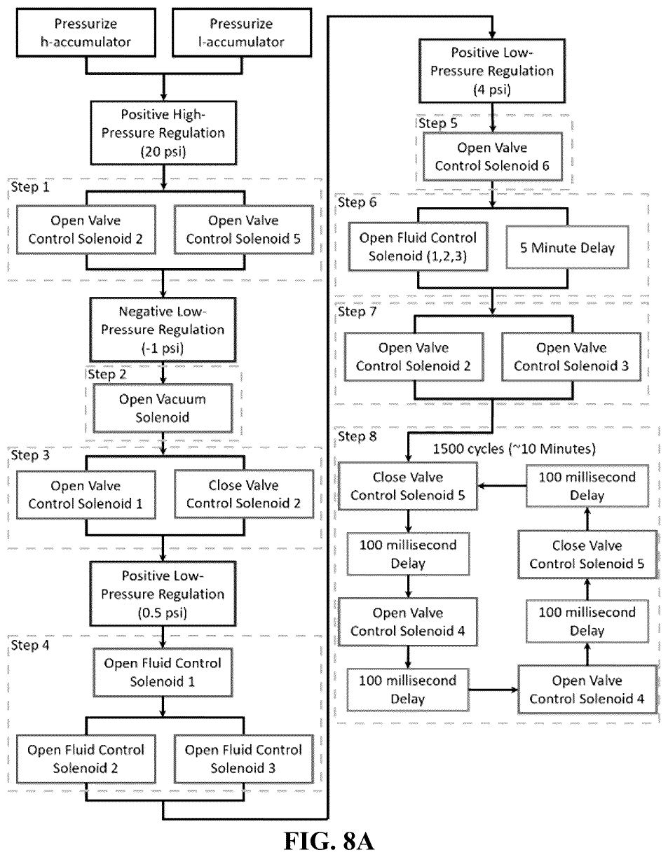

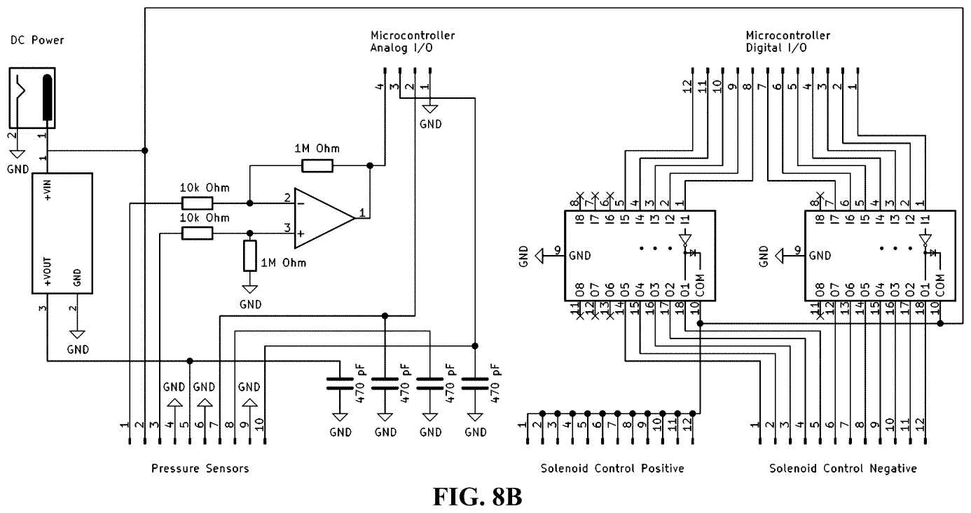

We used a microcontroller board and off-the-shelf electronics to control the pneumatic components described above. One dual DC motor controller interfaced both mini-pumps with the microcontroller, allowing for their individual activation. Pressure regulation was achieved by setting the mini-pump, digital pressure sensor, and the vent valve in a feedback loop such that the mini-pump increased the pressure in the accumulator to a setpoint while the vent solenoid released the excess pressure from the accumulator to the atmosphere. The pumping and venting process was monitored by the pressure sensor connected in parallel with the accumulator and was controlled with an in-house control algorithm. In this manner, the high-pressure system could deliver up to 25 psig with 1% precision (FIG. 5A) to activate the microvalves. The pneumatic connections of the high-pressure system are shown in FIG. 4A. The digital pressure sensor and solenoid valves were interfaced to the microcontroller via a custom-made PCB (FIG. 8B).

The low-pressure system was configured in a similar fashion but contained an additional pressure regulation component for negative pressure. By connecting a negative pressure regulator to the inlet of the mini-vacuum pump and a positive pressure regulator to the outlet of the mini-vacuum pump, negative and positive pressure sources could be achieved with a single system, as shown in FIG. 4B. Negative pressure was generated by the mini-pump and regulated in the same manner as the high- and low-pressure subsystems, with the difference that there was not an accumulator connected. The low-pressure system could deliver pressure in the range of −5 to +5 psig within 1% precision and with 3% precision at 0.5 psig (FIG. 5B-5C).

### Example 5: Automated Isolation of Plasma from Blood Using a Microfluidic Device

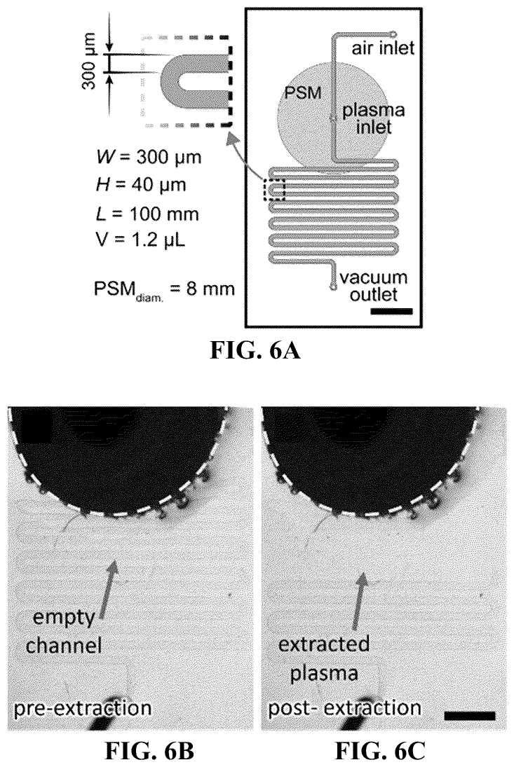

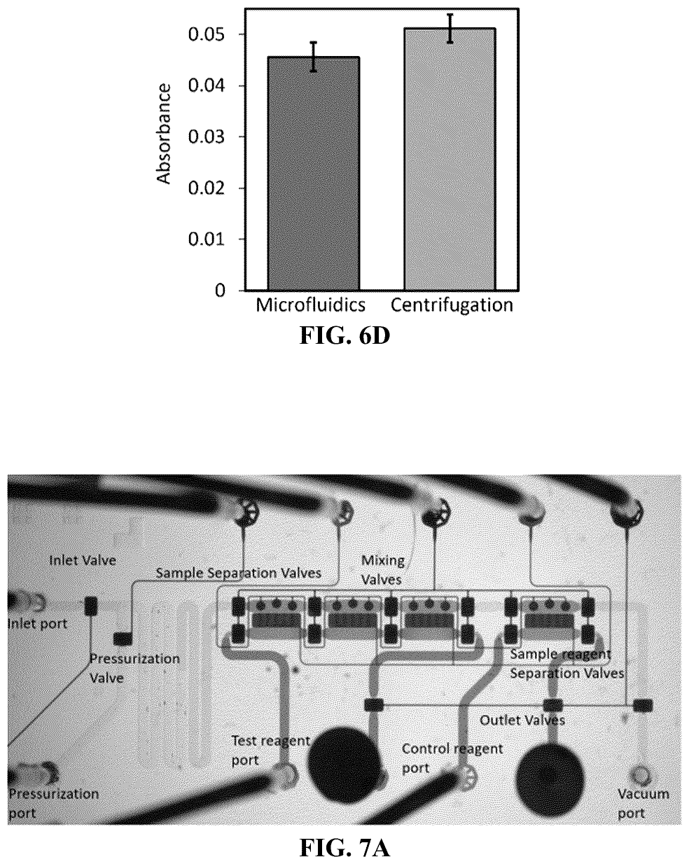

As an initial experiment, we tested the capabilities of our control system to separate plasma from whole blood in a simple microfluidic device. The microfluidic device included a single serpentine microchannel capable of retaining up to 1 μL of plasma. A plasma separation membrane (PSM) was bonded to an inlet of the device and used to deposit the whole blood sample (8 μL). The schematic of the device is shown in FIG. 6A.

Upon application of negative pressure (−1 psig) to the outlet of the device, all blood cells were retained in the PSM and plasma entered the serpentine, filling it completely, as shown in FIG. 6B-6C. The extracted plasma was collected and kept in a collection tube. This was repeated three times to obtain three samples of plasma from the same blood sample from three different devices. The remaining blood was used to separate plasma by centrifugation, the gold standard method.

Hemoglobin absorbance assay was used to assess lysis of red blood cells after performing plasma extraction. Hemoglobin levels were detected in all samples using a commercial kit and a spectrophotometer and compared directly between both separation methods. As seen in FIG. 6D, hemoglobin levels were similar in a microfluidic device compared to a standard centrifugation-based method. This result demonstrated that the control system could be used to drive automated separation of plasma from blood.

### Example 6: Initial Experiments Regarding Delivery of Plasma to a Microfluidic Device

Upon assessing the quality of extracted plasma, initial experiments were performed to deliver plasma into sample chambers, followed by mixing of sample and reagents. As shown in FIG. 7A, the microfluidic device included four ports for fluid flow control and six ports for microvalve actuation. For such an application, the automated microfluidic control system actuates multiple fluids independently in a sequential or parallel manner while actuating microvalves in six independent microchannels. The h-accumulator is pressurized to ˜5 psi. Next, the valve control solenoid 1 through 6 are opened to pressurize the microvalves before the automation process.

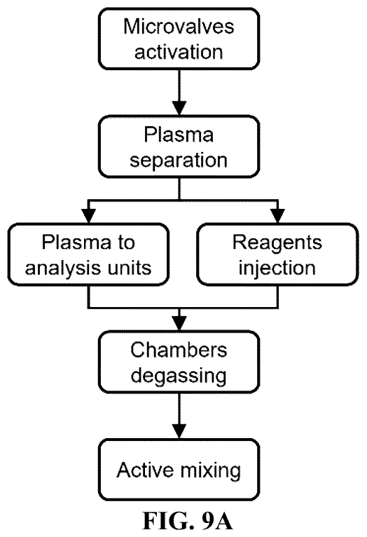

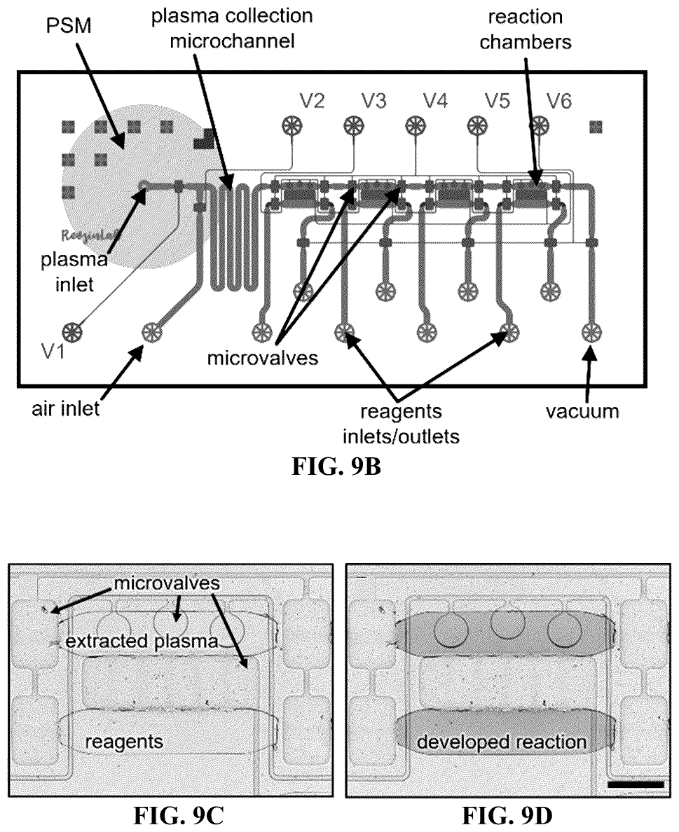

A systems-level flow diagram is provided in FIG. 8A, which shows a non-limiting automated glucose assay process. The process starts by closing valve control solenoid 1 through 6 and pressurizing the h-accumulator to ˜20 psi. After loading 5-10 μL of whole blood to the microfluidic inlet port, the program executes eight sequential microvalve and/or fluidic control steps. The sequence starts with opening valve control solenoids 2 and 5 to close the pressurization and sample reagent separation valves (step 1), followed by opening the vacuum solenoid to apply negative pressure (˜1 psi) to the vacuum port to pull the plasma from the whole blood into the serpentine microchannel (step 2) via a plasma separation membrane. The vacuum solenoid is closed to stop the negative pressure. Next, valve control solenoid 1 is opened to close the inlet valve and valve control solenoid 2 is close to open the pressurization valve (step 3). Fluid control solenoid 1 is opened to apply positive pressure (˜0.5 psi) to the pressurization port to push the plasma into the sample chambers. Fluid control solenoid 1 is closed to stop the positive pressure. In parallel, fluid control solenoid 2 and 3 is opened to supply two independent positive pressure sources (˜0.5 psi) to fill the test reagent and control reagent chamber (step 4). Fluid control solenoid 2 and 3 is closed to stop the positive pressure. Following, valve control solenoid 6 is opened to close the outlet valve (step 5). Excess gas is removed from the microsystem by pressurizing (˜4 psi) the sample and reagent chambers by opening the fluid control solenoid 1, 2, and 3 for 5 minutes (step 6). Fluid control solenoid 1, 2, and 3 is closed to stop the positive pressure. After bubble removal, valve control solenoid 2 and 3 are opened to close the pressurization and sample separation valves (step 7). The assay is complete after a 10-minute active mixing process by closing and opening valve control solenoid 4 and 5 to open and close the mixing and sample reagent separation valves alternating every 100 milliseconds to create a peristaltic pump action between the sample and reagent chambers (step 8). FIG. 8B shows a non-limiting electrical schematic. FIG. 9A-9D shows another implementation of automated operation of a microfluidic device, which is further discussed in the next Example.

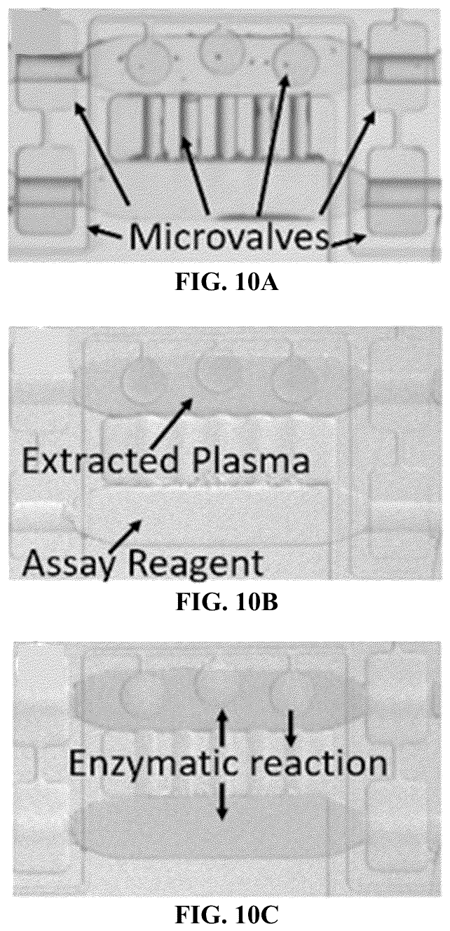

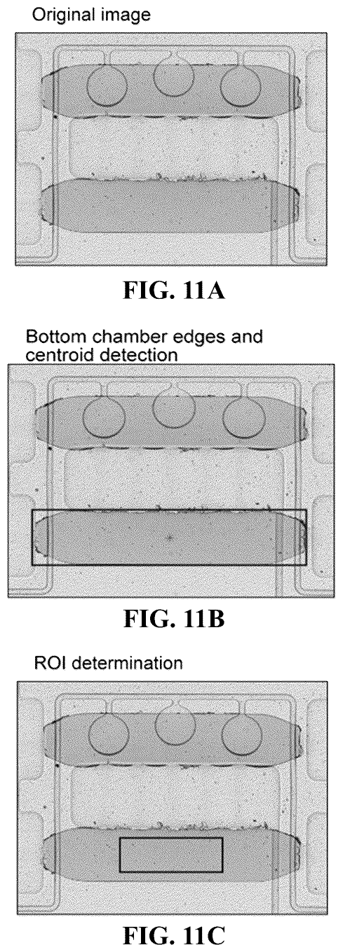

Upon finishing the automation sequence, the microcontroller can trigger the camera module to capture a post-colorimetric reaction for image analysis. FIGS. 9D, 10A-10C, and 11A-11D show non-limiting microscopic images of devices. Image analysis can identify the color intensity of the reaction chambers to compute the glucose level from the original whole blood sample.

### Example 7: Automated Operation of a Microfluidic Device Performing Enzymatic Glucose Assay

Having validated automated separation of plasma, we proceeded to employ the control system for automated performance of an enzymatic glucose assay. A systems-level flow diagram of the functions performed in the microfluidic device is shown in FIG. 9A. Before starting, the microfluidic device is set on the stage of an inverted tabletop microscope that has an integrated color camera. An iPad was used to acquire images. All microvalves were connected to the solenoid valves with tubing filled with DI water. The algorithm started by activating all six microvalves and pressurizing the accumulator to 25 psig to fill all microvalve channels. Immediately afterwards, all reagent tubing was loaded and connected to the device. Empty tubing was connected to the air inlet and vacuum outlet. A whole blood sample of 8 μL was then dispensed into the PSM. Following this, the control system performed six sequential steps that relied on the activation/deactivation of specific microvalves and pressurizing inlets/outlets to create fluid flow and mix sample with reagents. FIG. 9B shows the schematic of the microfluidic device depicting fluid flow channels and microvalves.

During the assay, the control system performed the next steps automatically: after the blood sample was deposited on the PSM, plasma was pulled into the collection microchannel by applying negative pressure to the outlet. Once collected, plasma was moved into the sample chambers, and reagents were loaded into the reagent chambers in parallel. At this point, the valves separating sample and reagent microchambers were actuated to prevent mixing. A degassing step was performed to remove air trapped inside the reaction chambers by pressurizing sample and reagents chambers for 3 min to allow air to diffuse-out through the PDMS. This step can be used to minimize the presence of bubbles, which can reside inside the chambers could prevent efficient mixing of solutions. Each bioanalysis unit was comprised of a sample microchamber and a reagent microchamber. One unit was sequestered from the neighboring unit by actuation of valves 4 and 5 and then the contents of the two microchambers within each unit were mixed to commence enzymatic reaction.

Active mixing is one component of our assay. Microfluidic devices often rely on diffusion for mixing of solutions, which requires waiting times of tens of minutes to hours, depending on the dimensions of the microchambers and solutions being mixed. To accelerate mixing, we sequentially activated two microvalves (V3 and V5) to create chaotic flow that moves solutions back and forth between the sample and reagent chambers. Such active mixing efficiently homogenizes the solutions and allows for the enzymatic glucose reaction to be completed in <8 min. Using the control system, we mixed solutions for 8 min during the active mixing step. Images were acquired from three chambers in the device and analyzed to determine glucose concentration. FIG. 9C-9D shows one bioanalysis unit before and after mixing of glucose with assay reagents. As may be seen from FIG. 9D, mixing of the glucose sample (8 mM) with assay reagents produces an intense magenta color.

### Example 8: Image Analysis to Quantify Colorimetric Enzymatic Glucose Assay

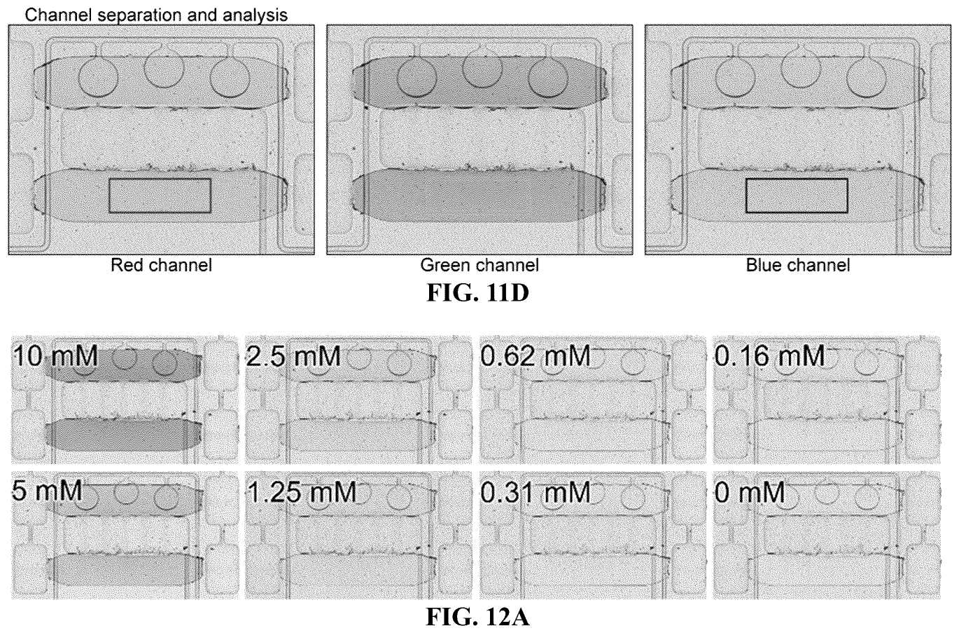

We developed a custom image analysis script using MATLAB to analyze the colorimetric reaction autonomously upon completing the fluid manipulation step. One function of the program is to calculate the intensity of the images acquired at the end of the enzymatic reaction. The software first opened all acquired images and aligned them to match the position of the bottom chambers in all of them. Then, the sample image was opened (FIG. 11A) and binarized to locate the sample and reagent chambers. The sample chamber was discarded, and the edges and geometrical centroid of the reagents chamber was determined (FIG. 11B). We did not use the sample chamber for analysis as the edges of the rounded microvalves could interfere with the analysis. A region of interest (ROI) in the middle of the reagents chamber (100×300 px) was determined for analysis (FIG. 11C). Then, each color channel (red-R, green-G, blue-B) from the original image was separated and the average intensity of the ROI was calculated for each channel (FIG. 11D). The pixel intensity values in all color channels were converted to the CMYK color space to determine magenta intensity. The same process was repeated for each image in all experiments.

### Example 9: Detecting Glucose in Blood Using a Microfluidic Device Operated by the Control System

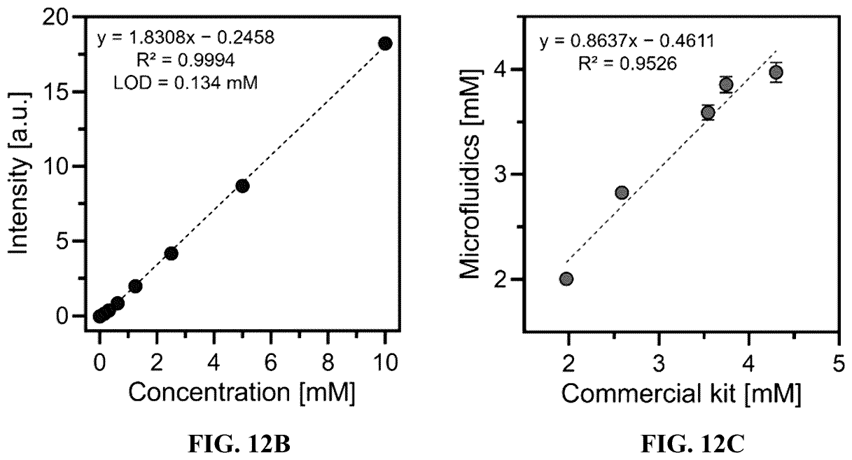

We first used solutions with known glucose concentrations to create a calibration curve. For this set of experiments, glucose solutions were introduced by connecting tubing to the plasma inlet and drawing the solutions into the sample chambers. All other steps were performed as described above. The reactions were developed by mixing of glucose solutions ranging from 0 to 10 mM with assay reagents (FIG. 12A). Images from three chambers were acquired and analyzed using the MATLAB script; and intensity values were plotted as a function of glucose concentration as shown in FIG. 12B.

These results demonstrate that a microfluidic device operated by the control system provides a limit of detection (LOD) of 0.134 mM glucose. This is comparable to limits of detection reported by us previously for an automated microfluidic device controlled by standard laboratory equipment.

In assessing the utility of the microfluidic device operated by the control system, we wanted to benchmark glucose detection from whole blood in our system against a commercial glucose assay kit. We obtained five blood samples from the Mayo Clinic blood bank and then split each sample in two parts, one was analyzed in a microfluidic device, another using a commercial kit. We note that glucose levels in a microfluidic device were established based on a two-point calibration using 0- and 8-mM glucose. FIG. 12C compares glucose detection results from a microfluidic device and a commercial kit and shows excellent agreement between the two approaches (r²=0.96). We note, however, that a microfluidic device operated by the control system allowed us to fully automate blood processing and glucose detection steps, providing a result within 30 min based on an input of a few microliters of blood. Conversely, the standard assay was carried out using 0.5 mL of blood, required manual handling steps and centrifugation, and was completed in ˜2 h. The values for the data plotted in FIG. 12B-12C can be found in Table 1 and Table 2, respectively.

TABLE 1
CALIBRATION CURVE DATA

| Concentration [mM] | Mean Intensity [mM] | Std. dev. |
|---|---|---|
| 10 | 18.226 | 0.244 |
| 5 | 8.684 | 0.065 |
| 2.5 | 4.158 | 0.011 |
| 1.25 | 1.985 | 0.012 |
| 0.625 | 0.842 | 0.010 |
| 0.313 | 0.354 | 0.004 |
| 0.156 | 0.149 | 0.002 |
| 0 | −0.033 | 0.003 |

Table 1 provides information obtained from the glucose calibration curve experiment shown in FIG. 12B, showing the average magenta color intensity from the microfluidic chambers. The standard deviation was calculated from three technical replicates (n=3).

TABLE 2
BLOOD SAMPLES DATA

| Sample | Commercial kit [mM] | Microfluidics [mM] | Std. dev. |
|---|---|---|---|
| 1 | 3.744 | 3.856 | 0.077 |
| 2 | 1.969 | 2.004 | 0.053 |
| 3 | 2.585 | 2.825 | 0.049 |
| 4 | 4.300 | 3.972 | 0.095 |
| 5 | 3.543 | 3.588 | 0.072 |

Table 2 provides values obtained from glucose analysis in blood when comparing our microfluidic system against a commercial kit. Five blood samples were analyzed, and the data plotted is shown in FIG. 12C. The standard deviation was obtained by analyzing three technical replicates (n=3).

As can be seen, we describe the development of a control system that drives a valve-enabled microfluidic device to perform a sophisticated workflow of plasma isolation from whole blood followed by detection of a model biomarker (e.g., glucose) using an enzymatic assay. The control system was portable (280×280×80 mm) and incorporated components to apply and regulate pressure for actuating microvalves and metering flow. This control system eliminated the need for external pumps and/or source of pressure typically used for operating Quake-style valves in microfluidic devices. Microfluidic devices operated by the control system were shown to efficiently isolate plasma from microliter volumes of whole blood. Furthermore, an integrated automated workflow of plasma separation and glucose detection performed in the microfluidic device yielded similar results (glucose concentration) compared to a standard laboratory-based workflow involving manual handling steps, including centrifugation-based plasma separation. Our study addresses an overlooked question of how to operate sophisticated microfluidic devices with Quake-style valves at the point-of-care.

The present document encompasses other modifications to the systems, methods, processes, and components described herein. For instance, a signal transduction strategy can include miniaturized components. In one non-limiting example, miniature optical transducers (either microscope objectives or cell phone attachments) may be integrated with the control system herein to enable sample-in/answer-out functionality and fully autonomous operation at the point-of-care. Implementing a signal transducer with the control system and demonstrating detection of multiple analytes in the same automated device is encompassed by the present document.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An integrated system for controlling fluid flow in a microfluidic device, wherein said system comprises:
(a) a first pressure module configured to control pressure within a control layer of said microfluidic device, wherein said control layer comprises one or more valves;
(b) a second pressure module configured to control pressure within a flow layer of said microfluidic device, wherein said flow layer comprises one or more flow channels, and wherein said one or more valves of said control layer are configured to control flow within at least one of said one or more flow channels of said flow layer;
(c) an electronics module configured to transmit and receive one or more signals between (i) said electronics module and (ii) said first pressure module, said second pressure module, or both said first and said second pressure modules;
(d) a housing configured to house said first pressure module, said second pressure module, and said electronics module; and
(e) a user interface configured to transmit and receive one or more signals between said user interface and said electronics module.

2. The system of claim 1, wherein said first pressure module is configured to provide pressure to said control layer in a range from about 10 to about 100 psi or greater than about 10 psi.

3. The system of claim 1, wherein said second pressure module is configured to provide pressure to said flow layer in a range from about −10 to about 10 psi or about −20 to about 20 psi.

4. The system of claim 1, wherein said first pressure module comprises:
(i) one or more control valves;
(ii) a pump configured to provide increased pressure to at least one of said one or more control valves;
(iii) an optional accumulator configured to be in fluidic communication with said pump and at least one of said one or more control valves;
(iv) a vent configured to decrease pressure in said first pressure module; and
(v) an optional high pressure sensor configured to provide a pressure reading within said first pressure module.

5. The system of claim 4, wherein said one or more control valves comprises a solenoid valve.

6. The system of claim 1, wherein said first pressure module is configured to provide positive pressure to said control layer.

7. The system of claim 1, wherein said second pressure module comprises:
(i) one or more control valves;
(ii) a pump configured to provide increased pressure to at least one of said one or more control valves;
(iii) an optional accumulator configured to be in fluidic communication with said pump and at least one of said one or more control valves;
(iv) a vent configured to decrease pressure in said second pressure module;
(v) a vacuum source configured to provide decreased pressure to at least one of said one or more flow channels in said flow layer; and
(vi) an optional low pressure sensor configured to provide a pressure reading within said second pressure module.

8. The system of claim 7, wherein said one or more control valves comprises a solenoid valve.

9. The system of claim 1, wherein said second pressure module is configured to provide positive pressure, negative pressure, or both positive and negative pressure to said flow layer.

10. The system of claim 1, wherein said electronics module further comprises:
(i) a controller configured to provide instructions to said first pressure module, said second pressure module, or both said first and said second pressure modules;
(ii) an optional driver configured to receive instructions from said controller and to transmit said instructions to a pump in said first pressure module, a pump in said second pressure module, or a pump in said first pressure module and a pump in said second pressure module;
(iii) an optional power module configured to receive instructions from said controller and to transmit said instructions to a vent in said first pressure module, a vent in said second pressure module, or a vent in said first pressure module and a vent in said second pressure module;
(iv) an optional transistor array configured to receive instructions from said controller and to transmit said instructions to one or more control valves of said first pressure module or of said second pressure module or to at least one valve of said first pressure module and at least one valve of said second pressure module; and
(v) an optional pressure sensor configured to receive pressure information from said first pressure module, from said second pressure module, or from said first and said second pressure modules and to transmit said pressure information to said controller.

11. The system of claim 1, wherein said housing further comprises:
(i) a first port configured to provide a connection between said first pressure module and said control layer of said microfluidic device and
(ii) a second port configured to provide a connection between said second pressure module and said flow layer of said microfluidic device.

12. The system of claim 11, wherein said housing further comprises a third port configured to provide a connection between said electronics module and said user interface.

13. The system of claim 1, further comprising:
a data transmitter configured to transmit or receive data between said user interface and said electronics module; or between said user interface and a storage medium.

14. The system of claim 1, wherein said system does not include an external pressure source or an external pressure regulator.

15. A method for controlling fluid flow in a microfluidic device, said method comprising:
(a) providing a system of claim 1;
(b) fluidically connecting a first pressure module to a control layer of said microfluidic device, wherein said control layer comprises one or more valves;
(c) fluidically connecting a second pressure module to a flow layer of said microfluidic device, wherein said flow layer comprises one or more flow channels; and
(d) adjusting a pressure within said first pressure module, said second pressure module, or both said first and said second pressure modules to control fluid flow within at least one of said one or more flow channels,
wherein (b) and (c) can be conducted at the same time or in any order.

16. The method of claim 15, wherein said adjusting the pressure within said first pressure module comprises actuating at least one of said one or more valves in said control layer.

17. The method of claim 15, wherein said adjusting the pressure within said second pressure module comprises flowing a fluid in at least one of said one or more flow channels in said flow layer.

18. The method of claim 15, wherein said first pressure module is configured to provide pressure to said control layer in a range from about 10 to about 100 psi; or wherein said second pressure module is configured to provide pressure to said flow layer in a range from about −20 to about 20 psi; or wherein said first pressure module is configured to provide pressure to said control layer in a range from about 10 to about 100 psi and said second pressure module is configured to provide pressure to said flow layer in a range from about −20 to about 20 psi.

19. The method of claim 15, wherein said first pressure module is configured to provide positive pressure to said control layer; or wherein said second pressure module is configured to provide positive pressure, negative pressure, or both positive and negative pressure to said flow layer; or wherein said first pressure module is configured to provide positive pressure to said control layer and said second pressure module is configured to provide positive pressure, negative pressure, or both positive and negative pressure to said flow layer.

20. The method of claim 15, wherein said adjusting in (d) comprises:
delivering a test sample to at least one of said one or more flow channels,
optionally reacting, treating, or preparing said test sample; and
optionally imaging said microfluidic device.
